(19) United States
(12) Patent Application Publication
(10) Pub. No.: US 2023/0048441 A1
(43) Pub. Date: Feb. 16, 2023

(54) REPRESENTATIVE TASK GENERATION AND CURATION

(71) Applicant: Yohana LLC, Palo Alto, CA (US)

(72) Inventors: Yoky Matsuoka, Los Altos Hills, CA (US); Nitin Viswanathan, San Francisco, CA (US); Gwendolyn W. van der Linden, Redwood City, CA (US); Malia Beaulieu, San Jose, CA (US); Lingyun Liu, Sunnyvale, CA (US); Benjamin Deming, Campbell, CA (US); Sean Paterson, Mountain View, CA (US)

(21) Appl. No.: 17/819,506

(22) Filed: Aug. 12, 2022

Related U.S. Application Data
(60) Provisional application No. 63/232,469, filed on Aug. 12, 2021.

(51) Int. Cl. G06Q 10/10

(52) U.S. Cl. CPC G06Q 10/1097; G06Q 10/107

(57) ABSTRACT

Systems and methods for automatically providing templates for the creation of projects and tasks based on messages exchanged between members and assigned representatives are provided. A system receives, in real-time, a set of messages between a member and a representative as the set of messages are being exchanged. The system, based on these messages, automatically identifies issue. The system can further identify one or more templates for defining a task that is performable to address the issue. The system can present the one or more templates such that, when a template is selected and used to define a task, the task can be performed to address the issue.

### CROSS-REFERENCE TO RELATED APPLICATIONS

The present patent application claims the priority benefit of U.S. provisional patent application No. 63/232,469 filed Aug. 12, 2021, the disclosures of which are incorporated by reference herein.

### FIELD

The present disclosure relates to generating and curating projects and tasks in response to member indication of an issue for resolution. In one example, the systems and methods described herein may be used to identify and provide templates for the generation of tasks that may be performed for the benefit of a member. Further, the systems and methods described herein may be used to provide automated coordination for the performance of these tasks.

### SUMMARY

Disclosed embodiments may provide a framework automatically identify and recommend tasks and/or projects to a member of a task facilitation service in order to reduce the member's cognitive load. According to some embodiments, a computer-implemented method is provided. The computer-implemented method comprises receiving in real-time a set of messages between a member and a representative as the set of messages are being exchanged. The computer-implemented method further comprises automatically identifying an issue. The issue is identified based on the set of messages. The computer-implemented method further comprises identifying one or more templates for defining a task. The task is performable to address the issue. Further, the one or more templates are identified using a trained machine learning algorithm. The trained machine learning algorithm uses the set of messages and a set of available templates as input to identify the one or more templates. The computer-implemented method further comprises presenting the one or more templates. When a template from the one or more templates is selected to define the task, the task is generated. The computer-implemented method further comprises performing the task. The task performed according to one or more parameters associated with the task. Further, the one or more parameters are defined using the template. The computer-implemented method further comprises updating the trained machine learning algorithm. The trained machine learning algorithm is updated using the task, the template, and the set of messages.

In some embodiments, the computer-implemented method further comprises processing the set of messages using a Natural Language Processing (NLP) algorithm to identify one or more anchor terms. The one or more anchor terms correspond to the issue.

In some embodiments, the computer-implemented method further comprises generating one or more proposal options for completion of the task. The one or more proposal options are generated based on the task. Further, when a proposal option is selected, the task is performed according to the selected proposal option.

In some embodiments, the computer-implemented method further comprises updating a console to present data fields for defining the one or more parameters associated with the task. The console is updated when the template is selected to define the task. Further, the data fields correspond to a task type associated with the task.

In some embodiments, the computer-implemented method further comprises dynamically generating one or more prompts for the additional information. When the one or more prompts are generated, the one or more prompts are provided to obtain the additional information. The computer-implemented method further comprises updating the template based on the additional information.

In some embodiments, the computer-implemented method further comprises facilitating a communications session corresponding to the task. The communications session is facilitated between the member and the representative. The computer-implemented method further comprises automatically presenting information corresponding to the task through the communications session.

In some embodiments, the computer-implemented method further comprises transmitting a notification in response to identifying the issue. When the notification is received by the representative, the issue and the one or more templates are dynamically presented to the representative.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a new project or task is generated using a template corresponding to an identified issue expressed by a member via a communications session between the member and an assigned representative in accordance with at least one embodiment;

FIG. 2 shows an illustrative example of an environment in which a task recommendation system provides a set of templates for defining new tasks and/or projects, as well as generates and ranks recommendations for different projects and/or tasks that can be presented to a member in accordance with at least one embodiment;

FIGS. 3A-3B show an illustrative example of an environment in which a representative, via a representative console, is provided with one or more templates that can be selected to define a new project or task on behalf of a member in accordance with at least one embodiment;

FIG. 4 shows an illustrative example of an environment in which a task creation sub-system dynamically identifies one or more templates for creation of a new project or task based on messages exchanged between a member and an assigned representative in accordance with at least one embodiment;

FIG. 5 shows an illustrative example of an environment in which a task creation sub-system provides, via a representative console, a task template for the creation of a new task to be performed for the benefit of a member in accordance with at least one embodiment;

FIG. 6 shows an illustrative example of an environment in which a task creation sub-system automatically identifies additional information that is required from a member for defining new projects and tasks in accordance with at least one embodiment;

FIG. 7 shows an illustrative example of an environment in which a task coordination system assigns and monitors performance of a task for the benefit of a member by a representative and/or one or more third-party services in accordance with at least one embodiment;

FIG. 8 shows an illustrative example of a process for generating a new project or task based on data provided via a selected template in accordance with at least one embodiment;

FIG. 9 shows an illustrative example of a process for identifying templates usable to generate a new project or task based on messages exchanged between a member and an assigned representative in accordance with at least one embodiment;

FIG. 10 shows an illustrative example of an environment in which communications with members are processed in accordance with at least one embodiment; and

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to automatically identify and recommend tasks and/or projects to a member of a task facilitation service in order to reduce the member's cognitive load. Through this framework, the task facilitation service can monitor, in real-time, communications between a member and an assigned representative as these communications are exchanged to automatically identify possible tasks that can be performed for the benefit of the member. Further, the task facilitation service can automatically, and in real-time, identify any additional information that may be required for the creation of these tasks. Once these tasks have been created, the task facilitation service can coordinate with the representative and/or third-party services to perform these tasks for the benefit of the member.

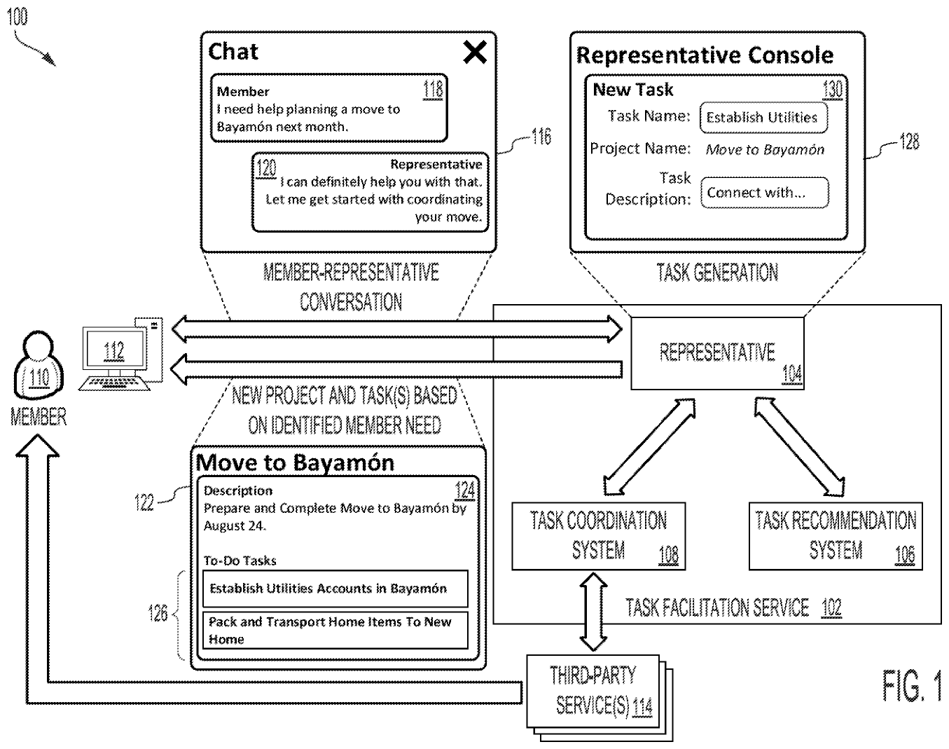

FIG. 1 shows an illustrative example of an environment 100 in which a new project or task is generated using a template corresponding to an identified issue expressed by a member 110 via a communications session 116 between the member 110 and an assigned representative 104 in accordance with at least one embodiment. In the environment 100, a member 110 of the task facilitation service 102 may be engaged with an assigned representative 104 through a communication session 116 facilitated by the task facilitation service 102. The member 110, through the communications session 116, may transmit one or more messages 118 to the representative 104 to indicate that the member 110 requires assistance in completing a project and/or task for the benefit of the member 110. For example, as illustrated in FIG. 1, the member 110 may indicate that they require the representative's assistance in planning a move to a new city in the next month. The representative 104, in response to these one or more messages 118 may indicate, via one or more messages 120, that they may be able to assist the member 110 in completing the particular project and/or task through various methods available to the representative 104 and/or implemented by the task facilitation service 102, as described herein.

The task facilitation service 102 may be implemented to reduce the cognitive load on members and their families in performing various projects and tasks on behalf of these members and their families by identifying and delegating projects and tasks to representatives that may coordinate performance of these projects and tasks. A member, such as member 110, may be paired with a representative 104 during an onboarding process, through which the task facilitation service 102 may collect identifying information of the member 110. For instance, the task facilitation service 102 may provide, to the member 110, a survey or questionnaire through which the member 110 may provide identifying information usable to select a representative 104 for the member 110. The task facilitation service 102 may prompt the member 110 to provide detailed information with regard to the composition of the member's family (e.g., number of inhabitants in the member's home, the number of children in the member's home, the number and types of pets in the member's home, etc.), the physical location of the member's home, any special needs or requirements of the member 110 (e.g., physical or emotional disabilities, etc.), and the like. In some instances, the member 110 may be prompted to provide demographic information (e.g., age, ethnicity, race, languages written/spoken, etc.). The member 110 may also be prompted to indicate any information related to one or more projects and/or tasks that the member 110 wishes to possibly delegate to a representative 104. This information may specify the nature of these projects and/or tasks (e.g., gutter cleaning, installation of carbon monoxide detectors, party planning, etc.), a level of urgency for completion of these projects and/or tasks (e.g., timing requirements, deadlines, date corresponding to upcoming events, etc.), any member preferences for completion of these projects and/or tasks, and the like.

In an embodiment, the data associated with the member 110 is used by the task facilitation service 102 to create a member profile corresponding to the member 110. As noted above, the task facilitation service 102 may provide, to the member 110, a survey or questionnaire through which the member 110 may provide identifying information associated with the member 110. The responses provided by the member 110 to this survey or questionnaire may be used by the task facilitation service 102 to generate an initial member profile corresponding to the member 110. In an embodiment, once a representative has been assigned to the member 110, the task facilitation service 102 can prompt the member 110 to generate a new member profile corresponding to the member 110. For instance, the task facilitation service 102 may provide the member 110 with a survey or questionnaire that includes a set of questions that may be used to supplement the information previously provided during the aforementioned onboarding process. For example, through the survey or questionnaire, the task facilitation service 102 may prompt the member 110 to provide additional information about family members, important dates (e.g., birthdays, etc.), dietary restrictions, and the like. Based on the responses provided by the member 110, the task facilitation service 102 may update the member profile corresponding to the member 110.

In some instances, the member profile may be accessible to the member 110, such as through an application or web portal provided by the task facilitation service 102. Through the application or web portal, the member 110 may add, remove, or edit any information within the member profile. The member profile, in some instances, may be divided into various sections corresponding to the member, the member's family, the member's home, and the like. Each of these sections may be supplemented based on the data associated with the member 110 collected during the onboarding process and on any responses to the survey or questionnaire provided to the member 110 after assignment of a representative to the member 110. Additionally, each section may include additional questions or prompts that the member 110 may use to provide additional information that may be used to expand the member profile. For example, through the member profile, the member 110 may be prompted to provide any credentials that may be used to access any external accounts (e.g., credit card accounts, retailer accounts, etc.) in order to facilitate completion of tasks and projects.

The collected identifying information may be used by the task facilitation service 102 to identify and assign a representative 104 to the member 110. For instance, the task facilitation service 102 may use the identifying information of a member 110, as well as any information related to the member's level of comfort or interest in delegating tasks to others, and any other information obtained during the onboarding process as input to a classification or clustering algorithm configured to identify representatives that may be well-suited to interact and communicate with the member 110 in a productive manner. Using the classification or clustering algorithm, the task facilitation service 102 may identify a representative 104 that may be more likely to develop a positive, long-term relationship with the member 110 while addressing any tasks that may need to be addressed for the benefit of the member 110. In some instances, the task facilitation service 102 may select a representative 104 based on information corresponding to the availability of the set of representatives associated with the task facilitation service 102. For instance, the task facilitation service 102 may automatically select the first available representative from a set of representatives. In some instances, the task facilitation service 102 may automatically select the first available representative that satisfies one or more criteria corresponding to the member's identifying information. For example, the task facilitation service 102 may automatically select an available representative that is within geographic proximity of the member 110, shares a similar background as that of the member 110, and the like.

The representative 104 may be an individual that is assigned to the member 110 according to degrees or vectors of similarity between the member's and representative's demographic information. For instance, if the member 110 and the representative 104 share a similar background (e.g., attended university in the same city, are from the same hometown, share particular interests, etc.), the task facilitation service 102 may be more likely to assign the representative 104 to the member 110. Similarly, if the member 110 and the representative 104 are within geographic proximity to one another, the task facilitation service 102 may be more likely to assign the representative 104 to the member 110.

In an embodiment, the representative 104 can be an automated process, such as a bot, that may be configured to automatically engage and interact with the member 110. For instance, the task facilitation service 102 may utilize the responses provided by the member 110 during the onboarding process as input to a machine learning algorithm or artificial intelligence to generate a member profile and a bot that may serve as a representative 104 for the member 110. The bot may be configured to autonomously chat with the member 110 to generate tasks and proposals, perform tasks on behalf of the member 110 in accordance with any approved proposals, and the like as described herein. The bot may be configured according to the parameters or characteristics of the member 110 as defined in the member profile. As the bot communicates with the member 110 over time, the bot may be updated to improve the bot's interaction with the member 110.

When a representative 104 is assigned to the member 110 by the task facilitation service 102, the task facilitation service 102 may notify the member 110 and the representative 104 of the pairing. Further, the task facilitation service 102 may establish a communications session 116 between the member 110 and the assigned representative 104 to facilitate communications between the member 110 and the representative 104. For instance, via a web portal or an application provided by the task facilitation service 102 and installed on the computing device 112, the member 110 may exchange messages with the assigned representative 104 over the communications session 116. Similarly, the representative 104 may be provided with an interface, such as a representative console 128, through which the representative 104 may exchange messages with the member 110.

In an embodiment, the representative 104 can suggest one or more projects and/or tasks based on member characteristics, task history, and other factors. For instance, as the member 110 communicates with the representative 104 over the communications session 116 and/or through any other communications session facilitated for different tasks and projects, the representative 104 may evaluate any messages 118 from the member 110 to identify any projects and/or tasks that may be performed to reduce the member's cognitive load. As an illustrative example, if the member 110 indicates, over the communications session 116, that their spouse's birthday is coming up, the representative 104 may utilize their knowledge of the member 110 to develop one or more projects and/or tasks that may be recommended to the member 110 in anticipation of their spouse's birthday. The representative 104 may recommend tasks such as purchasing a cake, ordering flowers, setting up a unique travel experience for the member 110, and the like. In some embodiments, the representative 104 can generate project and/or task suggestions without member input. For instance, as part of the onboarding process, the member 110 may provide the task facilitation service 102 with access to one or more member resources, such as the member's calendar, the member's personal fitness devices (e.g., fitness trackers, exercise equipment having communication capabilities, etc.), the member's vehicle data, and the like. Data collected from these member resources may be monitored by the representative 104, which may parse the data to generate project and/or task suggestions for the member 110.

In an embodiment, a representative 104, through a representative console 128 provided by the task facilitation service 102, can generate a new project or task that may be performed for the benefit of the member 110. For instance, via the representative console 128, the representative 104 may submit a request to a task recommendation system 106 of the task facilitation service 102 to generate a new project or task. The task recommendation system 106 may be implemented using a computer system or as an application or other executable code implemented on a computer system of the task facilitation service 102. In response to the request from the representative 104 to generate a new project or task that is to be performed for the benefit of the member 110, the task recommendation system 106 may identify one or more templates that may be used by the representative 104 to define the new project or task. The one or more task templates may correspond to the task type or category for the projects and/or tasks being defined. For example, if the member 110 has specified, via one or more messages 118 to the representative 104 over the communications session 116, that the member 110 requires assistance with an upcoming move to a new city, the representative 104, via the representative console 128, may select a template corresponding to moving projects and tasks.

In an embodiment, in response to a request from the representative 104 to generate a new project or task that may be performed for the benefit of the member 110, the task recommendation system 106 may dynamically evaluate the messages 118 exchanged between the member 110 and the representative 104 over the communications session 116 to identify one or more templates that may be relevant to the new project or task that is to be defined by the representative 104. For instance, in an embodiment, the task recommendation system 106 utilizes a machine learning algorithm, such as natural language processing (NLP), or other artificial intelligence to process these messages in real-time and exchanged between the member 110 and the representative 104 over the communications session 116 to identify one or more parameters corresponding to projects and/or tasks that may be generated by the representative 104. In some instances, the task recommendation system 106 may identify one or more keywords or anchor terms that may correspond to particular projects or tasks. As an illustrative example, if the member 110 transmits the message “I need help planning a move to Bayamon next month,” the task recommendation system 106 may identify the keywords “help” and “move,” which may be indicative of a request for help and of a project or task related to moving, respectively.

In an embodiment, the task facilitation service 102 may maintain a resource library that may serve as a repository for different project and task generation templates. These project and task generation templates may correspond to different project and task types or categories. For example, the task facilitation service 102 may maintain, within the resource library, a project generation template for projects related to member relocations to a new location. As another illustrative example, the task facilitation service 102 may maintain a project generation template for projects that may be related to event planning (e.g., birthday parties, anniversaries, etc.). As yet another illustrative example, the task facilitation service 102 may maintain a project generation template for projects that may be related to meal planning. The different project generation templates may include different data fields that may be used to define a particular project and corresponding tasks that may be completed for the benefit of the member 110. For example, a project generation template corresponding to member relocations may include data fields through which a representative 104 may define the member's current home size, the member's current utilities, any time restrictions or deadlines for the relocation, and the like.

In an embodiment, the templates maintained by the task facilitation service 102 in the resource library for defining new projects and tasks are associated with particular keywords or anchor terms that may be used to identify appropriate templates for different project or task categories or types. For example, a template corresponding to vehicle maintenance projects and tasks may be associated with the keywords “vehicle,” “automobile,” “car,” “van,” “engine,” and the like. Accordingly, if the member 110 indicates, via a message 118 to the representative 104 over the communications session 116, that the member 110 would like assistance with replacing the engine on the member's car, the task recommendation system 106 may use the keywords “engine” and “car” to automatically query the resource library and identify the template corresponding to vehicle maintenance projects and tasks maintained in the resource library.

The machine learning algorithm or other artificial intelligence used by the task recommendation system 106 to identify, from the resource library, one or more templates that may be provided to the representative 104 for defining a new project or task may be trained using supervised training techniques. For instance, a dataset of input messages, templates, and corresponding projects and tasks (and corresponding parameters) can be selected for training of the machine learning algorithm or other artificial intelligence. The machine learning algorithm or artificial intelligence may be evaluated to determine, based on the sample inputs supplied to the machine learning algorithm or artificial intelligence, whether the machine learning algorithm or artificial intelligence is accurately identifying templates that may be provided to the representative 104 based on the supplied messages. Based on this evaluation, the machine learning algorithm or artificial intelligence may be modified to increase the likelihood of the machine learning algorithm or artificial intelligence to accurately identify templates corresponding to the sample messages provided as input. The machine learning algorithm or artificial intelligence may further be dynamically trained by soliciting feedback from representatives of the task facilitation service 102 with regard to the identification of templates based on communications sessions between these members and representatives. For instance, if the task recommendation system 106 determines that the machine learning algorithm or artificial intelligence has failed to identify an appropriate template for creation of a project or task that a member 110 would have liked to have completed to address an issue, the task recommendation system 106 may use this feedback, along with the corresponding messages submitted by the member 110 identifying the issue and the template used by the representative 104 to define the project or task for addressing the issue, to retrain the machine learning algorithm or artificial intelligence to better identify templates based on similar messages from members of the task facilitation service 102.

In an embodiment, the machine learning algorithm or other artificial intelligence used to identify one or more templates that may be provided to the representative 104 may be dynamically trained based on communications exchanged between the member 110 and the representative 104 through the communications session 116 and/or through project- or task-specific communications sessions corresponding to the project or task (respectively) being performed for the benefit of the member 110. This dynamic training of the machine learning algorithm or other artificial intelligence may be performed in real-time and as these communications are exchanged over the communications session 116 and/or through project- or task-specific communications sessions corresponding to the project or task. For example, if the member 110 communicates to the representative 104 that the new project or task created to address the issue previously communicated by the member 110 does not appear to correspond to this issue, the task recommendation system 106 may automatically, and in real-time, use this feedback to dynamically update the machine learning algorithm such that, for similar issues, the likelihood of selection of the template used for creation of the new project or task is reduced. Alternatively, if the member 110 communicates to the representative 104 that they are pleased with the new project or task created to address the issue previously communicated by the member 110, the task recommendation system 106 may automatically, and in real-time, use this feedback to dynamically update the machine learning algorithm such that, for similar issues, the likelihood of selection of the template used for creation of the new project or task is maintained or increased.

Additionally, the machine learning algorithm or other artificial intelligence used to identify one or more templates that may be provided to the representative 104 and to other representatives may be continuously trained in real-time based on communications exchanged amongst the various members and representatives associated with the task facilitation service 102. For instance, the dynamic and real-time training of the machine learning algorithm or other artificial intelligence described above may be performed in parallel for different projects or tasks associated with the member 110 and other members. For example, the task recommendation system 106 may continuously process, in real-time, communications exchanged between different members and different representatives for different projects or tasks as these communications are exchanged to obtain feedback corresponding to the selection of templates for creation of new projects or tasks. As this feedback is obtained in real-time, the task recommendation system 106 may continuously update the machine learning algorithm or other artificial intelligence to ensure that the machine learning algorithm or other artificial intelligence is providing accurate results (e.g., project and task templates).

In an embodiment, the task recommendation system 106 can implement one or more classical algorithms or processes that may be used to automatically identify one or more templates that may be provided to the representative 104 for defining a new project or task. For instance, the one or more classical algorithms or processes may automatically, and in real-time, process communications between the member 110 and the representative 104 through the communications session 116 as these communications are exchanged. From these communications, the one or more classical algorithms or processes may automatically determine whether these communications include one or more anchor terms or phrases corresponding to an issue that the member 110 would like resolved. For example, from the message 118 “I need help planning a move to Bayamon next month” communicated by the member 110, the one or more classical algorithms or processes may automatically detect the anchor phrases “need help” and “planning a move.” Using these anchor phrases, the one or more classical algorithms may automatically query the resource library to identify any available templates corresponding to these anchor phrases. For instance, each template may be associated with one or more keywords or anchor terms that may be used to denote the project or task type or category for the template. Thus, in response to this query, the one or more classical algorithms or processes may identify the one or more templates corresponding to these anchor phrases.

The representative 104, via the representative console 128, may select an appropriate template for defining a new project or task. Alternatively, if the representative 104 does not identify an appropriate template for defining the new project or task, the representative 104 may generate a new custom template for the new project or task. For instance, the representative 104 may submit a request to the task recommendation system 106 to access a default template that includes various generic data fields for defining a new project or task. For instance, the default template may include data fields that may be used to define a name for the new project or task, a deadline for completion of the new project or task, a budget for completion of the new project or task, a priority for the new project or task, and a short description of the new project or task. Further, the default template may include various options for the representative 104 to add new data fields to the template that may be specific to the new project or task. For example, if the new project or task is being created for cleaning the gutters at the member's home, the representative 104 may add a data field to the template to indicate the type of gutters at the member's home, the type of cleaning that is to be performed on these gutters, any other issues related to these gutters (e.g., leakage, obstructions, damage, etc.), and the like. The representative 104, in some instances, may store or otherwise make available, through the resource library, this custom template for use by other representatives of the task facilitation service for similar projects or tasks. This custom template may be assigned one or more keywords or other anchor terms that may be used to identify the custom template for creation of similar projects or tasks.

In an embodiment, the task facilitation service 102 can automatically populate one or more data fields from a selected template based on information provided in the member profile associated with the member 110. For example, if the selected project generation template corresponds to a member relocation to a new location, the task facilitation service 102 may automatically populate any data fields within the template corresponding to the member's current home based on information within the member profile that indicates different parameters corresponding to the member's home (e.g., physical address, square footage, family composition, etc.). As another illustrative example, if the selected template corresponds to a project for planning a birthday party, the task facilitation service 102 may automatically process the member profile associated with the member 110 to determine any of the member's budget restrictions or preferences, any previously used venues for similar events (e.g., previously held birthday parties, etc.), the person for whom the birthday is being held based on family member birthdates, and the like. Based on this information, the task facilitation service 102 may automatically process the member profile associated with the member 110 to automatically populate any relevant data fields within the template for this particular event.

The representative 104, via a template for a particular project or task, may define various parameters associated with the new project or task that is to be presented and performed for the benefit of the member 110. For instance, via a selected or newly defined template, the representative 104 may define an assignment of the task (e.g., to the representative 104, to a third-party service 114 or other service/entity affiliated with the task facilitation service 102, to the member 110, etc.). In some instances, the task recommendation system 106 may use a machine learning algorithm or artificial intelligence to identify which data fields are to be presented in the task template to the representative 104 for creation of a new task or project. For example, the task recommendation system 106 may use, as input to the machine learning algorithm or artificial intelligence, a member profile associated with the member 110 and the selected task template for the new project or task. The task recommendation system 106 may indicate which data fields may be omitted from the project or task when presented to the member 110. Thus, the representative 104 may be required to provide all necessary information for a new task or project regardless of whether all information is presented to the member 110 or not.

The machine learning algorithm or artificial intelligence used to identify the data fields that are to be presented, via the representative console 128, in the template presented through the task creation window 130 to the representative 104 for creation of a new task or project may be trained using unsupervised training techniques. For instance, a dataset of input member attributes and task/project attributes may be analyzed using a clustering algorithm to identify correlations between different types of members and tasks/projects. Example clustering algorithms that may be trained using sample member attributes and representative attributes (e.g., historical data, hypothetical data, etc.) to identify potential pairings may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of the machine learning algorithm or artificial intelligence generated using the member attributes and task/project attributes as input, the task recommendation system 106 may identify the data fields that are to be presented in the task creation window 130 and corresponding to the template for the new project or task via the representative console 128.

In an embodiment, once the representative 104 has defined a new project or task based on messages 118-120 exchanged between the member 110 and the representative 104 over the communications session 116, the task recommendation system 106 provides the one or more new projects and/or tasks, along with the member's existing or pending projects and/or tasks, to the representative 104 to allow the representative 104 to evaluate these projects and/or tasks and determine which projects and/or tasks to present to the member 110. For instance, a listing of the one or more projects and/or tasks that may be recommended to the member 110 may be provided to the representative 104 for a final determination as to which projects and/or tasks may be presented to the member 110 through a project- or task-specific interface 122 provided to the member 110. In an embodiment, the task recommendation system 106 can rank the projects and/or tasks (new and/or pending) based on a likelihood of the member 110 selecting the project and/or task for delegation to the representative 104 for performance and/or coordination with third-party services 114. Alternatively, the task recommendation system 106 may rank the projects and/or tasks based on the level of urgency for completion of each project and/or task. The level of urgency may be determined based on member characteristics (e.g., data corresponding to a member's own prioritization of certain tasks or categories of tasks) and/or potential risks to the member 110 if the project and/or task is not performed. For example, a task corresponding to replacement or installation of carbon monoxide detectors within the member's home may be ranked higher than a task corresponding to the replacement of a refrigerator water dispenser filter, as carbon monoxide filters may be more critical to member safety. As another illustrative example, if a member 110 places significant importance on the maintenance of their vehicle, the task recommendation system 106 may rank a project or task related to vehicle maintenance higher than a project or task related to other types of maintenance. As yet another illustrative example, the task recommendation system 106 may rank a project or task related to an upcoming birthday higher than a project or task that can be completed after the upcoming birthday.

In an embodiment, the task recommendation system 106 can automatically determine whether additional information is required from the member 110 for the creation of the new project or task. For instance, the task recommendation system 106 may process the newly generated project and/or task and information corresponding to the member 110 using a machine learning algorithm or artificial intelligence to automatically identify additional parameters for the project or task, as well as any additional information that may be required from the member 110 for the generation of proposals. For instance, the task recommendation system 106 may use the generated project or task, information corresponding to the member 110, and historical data corresponding to projects and/or tasks performed for other similarly-situated members as input to the machine learning algorithm or artificial intelligence to identify any additional information that may be required of the member 110 for defining the project and/or task. If the task recommendation system 106 determines that additional member input is required for the project or task, the task recommendation system 106 may provide the representative 104 with recommendations for questions that may be presented to the member 110 regarding the project or task. Returning to the “Move to Bayamon” project 124 example illustrated in FIG. 1, if the task recommendation system 106 determines that it is important to understand one or more parameters of the member's home (e.g., square footage, number of rooms, etc.) for the project, the task recommendation system 106 may provide a recommendation to the representative 104 to prompt the member 110 to provide these one or more parameters. The representative 104 may review the recommendations provided by the task recommendation system 106 and, via a project-specific communications session associated with the project 124, prompt the member 110 to provide the additional project parameters. This process may reduce the number of prompts provided to the member 110 in order to define a particular project or task, thereby reducing the cognitive load on the member 110.

In an embodiment, the task recommendation system 106 can further provide the representative 104 with recommendations for questions that may be presented to the member 110 regarding the project or task based on the member's preferences. For example, if the member 110 is known to be budget conscious, and the representative 104 and/or the task recommendation system 106 has not defined any budgets or budget restrictions for the task or project, the task recommendation system 106 may prompt the representative 104 to communicate with the member 110 via a project- or task-specific communications session corresponding to the project or task (respectively) to inquire about the member's budget for completion of the project or task. In an embodiment, the task recommendation system 106 can use a machine learning algorithm or artificial intelligence to determine what questions may be provided to the member 110. For instance, the task recommendation system 106 may use the parameters defined for the new project or task, the member profile associated with the member 110, and historical data corresponding to projects and/or tasks previously performed for the benefit of the member 110 as input to the machine learning algorithm or artificial intelligence to determine the member's preferences and to identify questions that may be provided to the member 110 based on these preferences to further define the parameters of the new project or task.

In an embodiment, once the representative 104 has obtained the necessary task and/or project-related information from the member 110 and/or through the task recommendation system 106 (e.g., task parameters garnered via evaluation of tasks performed for similarly situated members, etc.), the representative can utilize a task coordination system 108 of the task facilitation service 102 to generate one or more proposals for resolution of the project and/or task. The task coordination system 108 may be implemented using a computer system or as an application or other executable code implemented on a computer system of the task facilitation service 102. In some examples, the representative 104 may utilize a resource library maintained by the task coordination system 108 to identify one or more third-party services 114 and/or resources (e.g., retailers, restaurants, websites, brands, types of goods, particular goods, etc.) that may be used for performance of the project and/or task for the benefit of the member 110 according to the one or more parameters identified by the representative 104 and the task recommendation system 106, as described above. A proposal may specify a timeframe for completion of the project and/or task, identification of any third-party services 114 (if any) that are to be engaged for completion of the project and/or task, a budget estimate for completion of the project and/or task, resources or types of resources to be used for completion of the project and/or task, and the like. The representative 104 may present the proposal to the member 110 via a project- or task-specific communications session corresponding to the new project or task (respectively) to be performed in order to solicit a response from the member 110 to either proceed with the proposal or to provide an alternative proposal for completion of the project and/or task.

In an embodiment, for a new project or task, the task recommendation system 106, automatically generates a specific communications session for the new project or task. This specific communications session corresponding to a particular project or task may be distinct from the communications session 116 previously established between the member 110 and the representative 104. Through this project- or task-specific communications session, the member 110 and the representative 104 may exchange messages related to the particular project or task. For example, through this project- or task-specific communications session, the representative 104 may prompt the member 110 for information that may be required to determine one or more parameters of the project or task. Similarly, if the member 110 has questions related to the particular project or task, the member 110 may provide these questions through the project- or task-specific communications session. The implementation of project- or task-specific communications sessions may reduce the number of messages exchanged through other chat or communications sessions, such as the communications session 116, while ensuring that communications within these project- or task-specific communications sessions are relevant to the corresponding projects or tasks.

Once a member 110 has selected a particular proposal option for a particular project or task, the new project and any corresponding tasks are presented to the member 110 via a project interface 122, through which the member 110 can review the project 124 corresponding to the stated issue and the tasks 126 corresponding to the selected proposal option from the proposal for the particular project 124. Through the project interface 122, the member 110 may review a description of the project 124 that is to be performed for the benefit of the member 110, as well as details regarding the corresponding tasks 126 that are to be performed in order to complete the project 124. For example, as illustrated in FIG. 1, the representative 104 or the task recommendation system 106 may update the project interface 122 to present the new project 124 related to the member's upcoming move to Bayamon and one or more tasks 126 corresponding to the project 124. The number of tasks 126 presented via the project interface 122 and the details provided for these tasks 126 and the project 124 itself may be determined based on the member's preferences or attributes specified in the member profile associated with the member 110. For instance, the amount of detail provided and the number of tasks 126 presented may be determined such that the member 110 is adequately informed with regard to the project 124 and corresponding tasks 126 while considering the member's cognitive load (e.g., the presentation of information does not add stress to the member 110, thereby maintaining the member's cognitive load). As noted above, the task recommendation system 106 may automatically generate a specific communications session for the new project once the new project has been created. This project-specific communications session may be presented within the project interface 122.

In an embodiment, each task 126 presented through the project interface 122 may be selectable such that, if a member 110 selects a particular task from the project interface 122, the task facilitation service 102 may dynamically update the project interface 122 to present a task-specific interface corresponding to the selected task. This task-specific interface may include similar elements to the project interface 122. For instance, if the member 110 selects the “Establish Utilities Accounts in Bayamon” task from the project interface 122, the task facilitation service 102 may dynamically update the project interface 122 to present a task-specific interface corresponding to this task. This task-specific interface may include a description of the task, as well as a task-specific communications session through which the member 110 and the representative 104 may exchange communications related to the task.

In some instances, the representative 104 may coordinate with one or more third-party services 114 and/or other services/entities affiliated with the task facilitation service 102 for completion of the project or task for the benefit of the member 110. For instance, the representative 104 may utilize a task coordination system 108 of the task facilitation service 102 to identify and contact one or more third-party services 114 and/or other services/entities affiliated with the task facilitation service 102 for performance of a project or task. As noted above, the task coordination system 108 may include a resource library that includes detailed information related to third-party services 114 and/or other services/entities affiliated with the task facilitation service 102. For example, an entry for a third-party service or other service/entity affiliated with the task facilitation service 102 in the resource library may include contact information for the third-party service, any available price sheets for services or goods offered by the third-party service, listings of goods and/or services offered by the third-party service, hours of operation, ratings or scores according to different categories of members, and the like. The representative 104 may query the resource library to identify the one or more third-party services 114 and/or other services/entities affiliated with the task facilitation service 102 that are to perform the project or task and determine an estimated cost for performance of the project or task. Further, the representative 104 may contact the one or more third-party services 114 and/or other services/entities affiliated with the task facilitation service 102 to obtain quotes for completion of the task and to coordinate performance of the project or task for the benefit of the member 110.

In some instances, the resource library may further include detailed information corresponding to other services and other entities that may be associated or affiliated with the task facilitation service 102 and that are contracted to perform various project and/or tasks on behalf of members of the task facilitation service 102. These other services and other entities may provide their services or goods at rates agreed upon with the task facilitation service 102. Thus, if the representative 104 selects any of these other services or other entities from the resource library, the representative 104 may be able to determine the particular parameters (e.g., price, availability, time required, etc.) for completion of the project and any associated tasks.

In an embodiment, for a given project or task, the representative 104 can query the resource library to identify one or more third-party services 114 and other services/entities affiliated with the task facilitation service 102 from which to solicit quotes for completion of the project or task. For instance, for a newly created task, the representative 104 may transmit a job offer to these one or more third-party services 114 and other services/entities. The job offer may indicate various characteristics of the task that is to be completed (e.g., scope of the task, general geographic location of the member 110 or of where the task is to be completed, desired budget, etc.). Through an application or web portal provided by the task facilitation service 102, a third-party service or other service/entity may review the job offer and determine whether to submit a quote for completion of the task or to decline the job offer. If a third-party service or other service/entity opts to reject the job offer, the representative may receive a notification indicating that the third-party service or other service/entity has declined the job offer. Alternatively, if a third-party service or other service/entity opts to bid to perform the task (e.g., accepts the job offer), the third-party service or other service/entity may submit a quote for completion of the task. This quote may indicate the estimated cost for completion of the task, the time required for completion of the task, the estimated date in which the third-party service or other service/entity is available to begin performance of the task, and the like.

The representative 104 may use any provided quotes from the third-party services 114 and/or other services/entities to generate different proposals for completion of the project or task. These different proposals may be presented to the member 110 through the project- or task-specific interface corresponding to the particular project or task that is to be completed. If the member 110 selects a particular proposal from the set of proposals presented through the project- or task-specific interface, the representative 104 may transmit a notification to the third-party service or other service/entity that submitted the quote associated with the selected proposal to indicate that it has been selected for completion of the project or task. Accordingly, the representative 104 may utilize the task coordination system 108 to coordinate with the third-party service or other service/entity for completion of the project or task.

In some instances, if the project or task is to be completed by the representative 104, the representative 104 may utilize the task coordination system 108 to identify any resources that may be utilized by the representative 104 for performance of the project or task. The resource library may include detailed information related to different resources available for performance of a project or task. As an illustrative example, if the representative 104 is tasked with purchasing a set of filters for the member's home, the representative 104 may query the resource library to identify a retailer that may sell filters of a quality and/or price that is acceptable to the member 110 and that corresponds to the proposal option accepted by the member 110. Further, the representative 104 may obtain available payment information of the member 110 that may be used to provide payment for any resources required by the representative 104 to complete the project or task. Using the aforementioned example, the representative 104 may obtain payment information of the member 110 from the member's profile to complete a purchase with the retailer for the set of filters that are to be used in the member's home.

If the representative 104 is able to coordinate with one or more third-party services 114 for performance of the project or task (e.g., schedule a time for performance of the project or task, agree upon a price for performance of the project or task, etc.), the representative 104 may update the project interface 122 to indicate when the project 124 and any associated tasks 126 are expected to be completed and the estimated cost for completion of the project 124 and the associated tasks 126. If any of the information provided in the update does not correspond to the estimates provided in the selected proposal option, the member 110 may be provided with an option to cancel the project 124 or particular task 126, or otherwise make changes to the project 124 or particular task 126. For instance, if the estimated cost for performance of a task 126 exceeds the maximum amount specified in the selected proposal option, the member 110 may ask the representative 104 to find an alternative third-party service 114 for performance of the task 126 within the budget specified in the selected proposal option. Similarly, if the timeframe for completion of the task 126 is not within the timeframe indicated in the selected proposal option, the member 110 can ask the representative 104 to find an alternative third-party service 114 for performance of the task 126 within the original timeframe. The member's interventions may be recorded by the task recommendation system 106 and the task coordination system 108 to retrain their corresponding machine learning algorithms or artificial intelligence to define more accurate proposal option parameters for the member 110 and to better identify third-party services 114 that may perform tasks within the defined proposal option parameters, respectively.

In an embodiment, once the representative 104 has contracted with one or more third-party services 114 for performance of a project or task, the task coordination system 108 may monitor performance of the project or task by these third-party services 114. For instance, the task coordination system 108 may record any information provided by the third-party services 114 with regard to the timeframe for performance of the project or task, the cost associated with performance of the project or task, any status updates with regard to performance of the project or task, and the like. Status updates provided by third-party services 114 may be provided automatically to the member 110 via the project interface 122 provided by the task facilitation service 102. Additionally, or alternatively, these status updates may be provided automatically to the representative 104 via a representative console.

In an embodiment, if the task is to be performed by the representative 104, the task coordination system 108 can monitor performance of the project or task by the representative 104. For instance, the task coordination system 108 may monitor, in real-time, any communications between the representative 104 and the member 110 regarding the representative's performance of the project or task. These communications may include messages 120 from the representative 104 over the communications session corresponding to the project or to the particular task being performed as part of the project indicating any status updates with regard to performance of the project or task, any purchases or expenses incurred by the representative 104 in performing the project or task, the timeframe for completion of the project or task, and the like. The task coordination system 108 may further use these messages from the representative 104 to automatically update the project interface 122 to provide the member 110 with updates related to the performance of the project 124 and any corresponding tasks 126.

Once a task or the corresponding project has been completed, the member 110 may be prompted to provide feedback with regard to completion of the project or task. For instance, the member 110 may be prompted to provide feedback with regard to the performance and professionalism of the selected third-party services 114 in performance of the project or task. Further, the member 110 may be prompted to provide feedback with regard to the quality of the proposal options provided by the representative 104 and as to whether the performance of the project or task has addressed the underlying issue associated with the project or task. Using the responses provided by the member 110, the task facilitation service 102 may train or otherwise update the machine learning algorithms or artificial intelligence utilized by the task recommendation system 106 and the task coordination system 108 to provide better assistance to the representative 104 for the creation of new projects or tasks, creation of proposals and corresponding proposal options, identification of third-party services 114 for completion of projects and tasks for the benefit of the member 110 and other similarly-situated members, identification of resources that may be provided to the representative 104 for performance of a project or task for the benefit of the member 110, and the like.

It should be noted that for the processes described herein, various operations performed by the representative 104 may be additionally, or alternatively, performed using one or more machine learning algorithms or artificial intelligence. For example, as the representative 104 performs or otherwise coordinates performance of projects and tasks on behalf of a member 110 over time, the task facilitation service 102 may continuously and automatically update the member's profile according to member feedback related to the performance of these projects and tasks by the representative 104 and/or third-party services 114. In an embodiment, the task recommendation system 106, after a member's profile has been updated over a period of time (e.g., six months, a year, etc.) or over a set of projects and tasks (e.g., twenty tasks, thirty tasks, etc.), may utilize a machine learning algorithm or artificial intelligence to automatically and dynamically generate new projects and tasks based on the various attributes of the member's profile (e.g., historical data corresponding to member-representative communications, member feedback corresponding to representative performance and presented tasks/proposals, etc.) with or without representative 104 interaction. The task recommendation system 106 may automatically communicate with the member 110 to obtain any additional information required for new projects and tasks and automatically generate proposals that may be presented to the member 110 for performance of these projects and tasks. The representative 104 may monitor communications between the task recommendation system 106 and the member 110 to ensure that the conversation maintains a positive polarity (e.g., the member 110 is satisfied with their interaction with the task recommendation system 106 or other bot, etc.). If the representative 104 determines that the conversation has a negative polarity (e.g., the member 110 is expressing frustration, the task recommendation system 106 or bot is unable to process the member's responses or asks, etc.), the representative 104 may intervene in the conversation. This may allow the representative 104 to address any member concerns and perform any projects and tasks on behalf of the member 110.

Thus, unlike automated customer service systems and environments, wherein these systems and environment may have little to no knowledge of the users interacting with agents or other automated systems, the task recommendation system 106 can continuously update the member profile to provide up-to-date historical information about the member 110 based on the member's automatic interaction with the system or interaction with the representative 104 and on the projects and tasks performed on behalf of the member 110 over time. This historical information, which may be automatically and dynamically updated as the member 110 or the system interacts with the representative 104 and as projects and tasks are devised, proposed, and performed for the member 110 over time, may be used by the task recommendation system 106 to anticipate, identify, and present appropriate or intelligent responses to member 110 queries, needs, and/or goals.

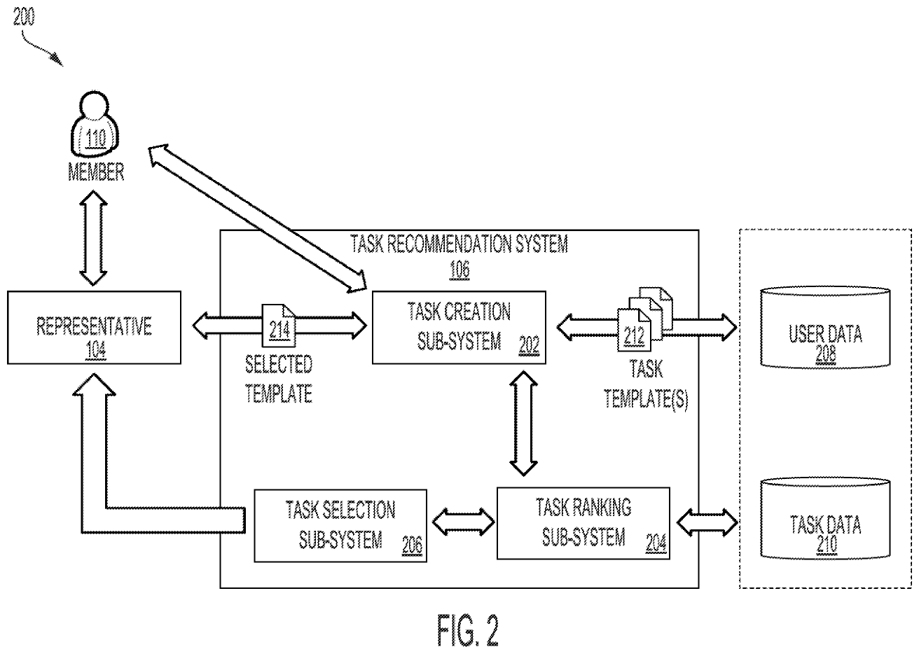

FIG. 2 shows an illustrative example of an environment 200 in which a task recommendation system 106 provides a set of templates 212 for defining new tasks and/or projects, as well as generates and ranks recommendations for different projects and/or tasks that can be presented to a member 110 in accordance with at least one embodiment. In the environment 200, a member 110 and/or representative 104 interacts with a task creation sub-system 202 of the task recommendation system 106 to generate a new task or project that can be performed for the benefit of the member 110. The task creation sub-system 202 may be implemented using a computer system or as an application or other executable code implemented on a computer system of the task recommendation system 106.

In an embodiment, a member 110 can access the task creation sub-system 202 to manually generate a new task or project that may be assigned to a representative 104 and/or one or more third-party services for performance of the new task or project for the benefit of the member 110. For instance, a member 110 may explicitly indicate to the representative 104 that they require assistance with regard to a particular issue. As an illustrative example, the member 110 may indicate, in a message to the representative 104 over a communications session, that they would like assistance with an upcoming move to a new town. The representative 104 may evaluate this message and determine that the member 110 has defined an issue for which a project and corresponding tasks may be generated to address the issue. Alternatively, the member 110 may directly access the task creation sub-system 202 to request creation of a project or task corresponding to a particular issue that the member 110 would like assistance with. For instance, the task facilitation service may provide, via an application or web portal of the task facilitation service, an option for manual entry of a project or task that may be delegated to the representative 104 or that may otherwise be added to the member's list of projects and tasks.

If the member 110 selects an option for manual entry of a project or task, the task facilitation service may provide, via an interface of the application or web portal, a project or task template through which the member may enter various details related to the project or task. The project or task template may include various fields through which the member 110 may provide a name for the project or task, a description of the project or task (e.g., “I need to have my gutters cleaned before the upcoming storm,” “I'd like to have painters touch up my powder room,” etc.), a timeframe for performance of the project or task (e.g., a specific deadline date, a date range, a level of urgency, etc.), a budget for performance of the project or task (e.g., no budget limitation, a specific maximum amount, etc.), and the like.

In some instances, if the member 110 selects an option for manual entry of a project or task, the task facilitation service may provide the member 110 with different project and task templates that may be used to generate a new project or task. As noted above, the task facilitation service may maintain a resource library that serves as a repository for different project and task templates corresponding to different project and task categories (e.g., vehicle maintenance tasks, home maintenance tasks, family-related event tasks, care giving tasks, experience-related tasks, etc.). A project or task template may include a plurality of project or task definition fields that may be used to define a project or task that may be performed for the benefit of the member 110. For example, the task definition fields corresponding to a vehicle maintenance task may be used to define the make and model of the member's vehicle, the age of the vehicle, information corresponding to the last time the vehicle was maintained, any reported accidents associated with the vehicle, a description of any issues associated with the vehicle, and the like. Thus, each template maintained in the resource library may include fields that are specific to the project or task category associated with the template.

In an embodiment, the representative 104, via a representative console provided by the task facilitation service, can query the resource library to obtain a particular template 214 for defining a new project or task. As noted above, each template 212 may be associated with one or more keywords or anchor terms that may be used to denote the project or task type or category for the template 212. Accordingly, the representative 104, via the representative console, may query the resource library using one or more keywords or anchor terms. The keywords or anchor terms may be selected by the representative 104 based on their knowledge of the issue specified by the member 110 via the communications session. For instance, if the representative 104 knows that the member 110 would like to have their house cleaned professionally, the representative 104 may query the resource library using the keywords “cleaning” and “home” to identify one or more templates 214 that correspond to the keywords “cleaning” and “home.” Thus, in response to this query, the resource library may evaluate the set of templates 212 from the task datastore 210 to identify the one or more templates 214 corresponding to these keywords or anchor terms. Further, the task creation sub-system 202 may update the representative console utilized by the representative 104 to present the identified one or more templates 214 that may be used to define the new project or task. This may allow the representative 104 to review the identified templates 214 and select an appropriate template for defining the new project or task.

In an embodiment, in response to a request from the member 110 or representative 104 to generate a new project or task, the task creation sub-system 202 can automatically, and in real-time, process messages exchanged between the member 110 and the representative 104 over the communications session to identify any keywords and/or anchor terms that may be used to identify, from the set of templates 212 maintained in the resource library, one or more templates 214 that may be associated with these keywords and/or anchor terms and used to generate the new project or task. For instance, the task creation sub-system 202 may use NLP or other artificial intelligence to process these messages exchanged between the member 110 and the representative 104 over the communications session to identify the one or more keywords or anchor terms that may correspond to particular projects or tasks. Using the identified one or more keywords or anchor terms, the task creation sub-system 202 may automatically query the resource library to identify one or more templates 214 that may be presented to the representative 104 for defining the new project or task.

In an embodiment, the task creation sub-system 202 can use feedback from the member 110 and/or representative 104 with regard to the identified one or more templates 214 to further train the NLP or artificial intelligence. For instance, if the representative 104 selects a particular template from the identified one or more templates 214 and proceeds to define a new project or task using the particular template, the task creation sub-system 202 may use this selection of the particular template as feedback, as well as the corresponding messages exchanged over any communications sessions between the member 110 and the representative 104 (e.g., the original communications session, the project- or task-specific communications session corresponding to the project or task, etc.), and the new project or task defined using the particular template to reinforce the NLP or artificial intelligence. This may increase the likelihood of the NLP or artificial intelligence identifying the appropriate keywords or anchor terms and the corresponding template based on similar messages exchanged between similarly situated members and representatives. Alternatively, if the representative 104 rejects the identified one or more templates 214 and instead selects a different template or creates a new custom template for the new project or task, the task creation sub-system 202 may use the rejection of the identified one or more templates 214 and the template actually used to define the new project or task as feedback, as well as the corresponding messages exchanged over any communications sessions between the member 110 and the representative 104, and the new project or task defined using the particular template to retrain the NLP or artificial intelligence. This may decrease the likelihood of the NLP or artificial intelligence of identifying the previously identified one or more templates 214 in response to the keywords or anchor terms detected from the exchanged messages. Further, this may increase the likelihood of the NLP or artificial intelligence of identifying the different or newly created template based on similar messages exchanged between similarly situated members and representatives.

In an embodiment, the data fields presented in a template 214 for a project or task can be selected based on a determination generated using a machine learning algorithm or artificial intelligence. For example, the task creation sub-system 202 can use, as input to the machine learning algorithm or artificial intelligence, a member profile from the user datastore 208 and the selected template 214 from the task datastore 210 (or the resource library) to identify which data fields may be omitted from the template 214 when presented to the representative 104 for definition of a new task or project. For instance, if the member 110 is known to delegate maintenance tasks to a representative 104 and is indifferent to budget considerations, the task creation sub-system 202 may present, to the representative 104, a template 214 that omits any budget-related data fields and other data fields that may define, with particularity, instructions for completion of the task. In some instances, the task creation sub-system 202 may allow the representative 104 to add, remove, and/or modify the data fields for the template 214. For example, if the task creation sub-system 202 removes a data field corresponding to the budget for the task based on an evaluation of the member profile, the representative 104 may request to have the data field added to the template 214 to allow the representative 104 to define a budget for the task based on their knowledge of the member 110. The task creation sub-system 202, in some instances, may utilize this change to the template 214 to retrain the machine learning algorithm or artificial intelligence to improve the likelihood of providing templates to the representative 104 without need for the representative 104 to make any modifications to the template 214 for defining a new project or task.

In an embodiment, the task creation sub-system 202 can automatically populate the data fields presented in a template based on parameters of the new project or task as identified from member messages exchanged over the communications session corresponding to the new project or task and/or the original communications session through which the member 110 communicated their request or desire for the representative 104 to assist the member 110 in addressing an issue. For instance, the task creation sub-system 202 may use NLP or other artificial intelligence to evaluate messages or other communications from the member 110 exchanged over these communications sessions in real-time to identify various parameters for the new project or task as these messages are exchanged. As an illustrative example, if the member 110 states, in a message to the representative 104, that they do not want to spend over $500 to address an identified issue, the task creation sub-system 202, using NLP or other artificial intelligence, may determine that the budget cap for the new project or task is $500 and input this value into the corresponding data field for the project or task. This may reduce the burden on the representative 104 to provide the required information for the new project or task.

In an embodiment, the task creation sub-system 202 can further provide, to the representative 104, recommendations for questions that may be presented to the member 110 regarding the project or task based on the member's preferences. For example, if the representative 104 has not defined any budgets or budget restrictions for a new task or project, and the task creation sub-system 202 determines that the member 110 is budget conscious, the task creation sub-system 202 may prompt the representative 104 to communicate with the member 110 via the communications session corresponding to the new task or project to inquire about the member's budget for completion of the project or task. In an embodiment, the task creation sub-system 202 can use a machine learning algorithm or artificial intelligence to determine what questions may be provided to the member 110. For instance, the task creation sub-system 202 may use the parameters defined for the new project or task, the member's profile, and historical data corresponding to projects and/or tasks previously performed for the benefit of the member 110 as input to the machine learning algorithm or artificial intelligence to determine the member's preferences and to identify questions that may be provided to the member 110 based on these preferences to further define the parameters of the new project or task.

The task recommendation system 106 may further include a task ranking sub-system 204, which may be configured to rank the tasks and/or projects associated with a member 110, including projects and/or tasks that may be recommended to the member 110 for completion by the member 110, the representative 104, or other third-party services and/or other services/entities associated with the task facilitation service. The task ranking sub-system 204 may be implemented using a computer system or as an application or other executable code implemented on a computer system of the task recommendation system 106. In an embodiment, the task ranking sub-system 204 can rank the member's projects and/or tasks based on a likelihood of the member 110 selecting the project or task for delegation to the representative 104 for performance and coordination with third-party services. Alternatively, the task ranking sub-system 204 may rank the member's projects and/or tasks based on the level of urgency for completion of each project or task. The level of urgency may be determined based on member characteristics from the user datastore 208 (e.g., data corresponding to a member's own prioritization of certain projects/tasks or categories of projects/tasks) and/or potential risks to the member 110 if the project or task is not performed.

In an embodiment, the task ranking sub-system 204 provides the ranked list of the projects and/or tasks that may be recommended to the member 110 to a task selection sub-system 206. The task selection sub-system 206 may be implemented using a computer system or as an application or other executable code implemented on a computer system of the task recommendation system 106. The task selection sub-system 206 may be configured to select, from the ranked list of the projects and/or tasks, which projects and/or tasks may be recommended to the member 110 by the representative 104. For instance, if the application or web portal provided by the task facilitation service is configured to present, to the member 110, a limited number of task and/or project recommendations from the ranked list of the projects and/or tasks, the task selection sub-system 206 may process the ranked list and the member's profile from the user datastore 208 to determine which project and/or task recommendations should be presented to the member 110. In some instances, the selection made by the task selection sub-system 206 may correspond to the ranking of the projects and/or tasks in the list. Alternatively, the task selection sub-system 206 may process the ranked list, as well as the member's profile and the member's existing projects and tasks (e.g., projects and tasks in progress, projects and tasks accepted by the member 110, etc.), to determine which projects and/or tasks may be recommended to the member 110. For instance, if the ranked list includes a task corresponding to gutter cleaning but the member 110 already has a task in progress corresponding to gutter repairs due to a recent storm, the task selection sub-system 206 may forego selection of the task corresponding to gutter cleaning, as this may be performed in conjunction with the gutter repairs. Thus, the task selection sub-system 206 may provide another layer to further refine the ranked list of the projects and/or tasks for presentation to the member 110.

The task selection sub-system 206 may provide, to the representative 104, a new listing of projects and/or tasks that may be recommended to the member 110. The representative 104 may review this new listing of projects and/or tasks to determine which projects and/or tasks may be presented to the member 110 via the project interface provided by the task facilitation service (as illustrated herein at FIG. 1) or through other interfaces corresponding to these one or more projects and/or tasks. For instance, the representative 104 may review the set of projects and/or tasks recommended by the task selection sub-system 206 and select one or more of these projects and/or tasks for presentation to the member 110 via individual interfaces corresponding to these one or more projects and/or tasks. In some instances, the one or more projects and/or tasks may be presented to the member 110 according to the ranking generated by the task ranking sub-system 204 and refined by the task selection sub-system 206. Alternatively, the one or more projects and/or tasks may be presented according to the representative's understanding of the member's own preferences for project and task prioritization. Through the project interface, the member 110 may select one or more projects and/or tasks that may be performed with the assistance of the representative 104 or third-party services. The member 110 may alternatively dismiss any presented projects and/or tasks that the member 110 would rather perform personally or that the member 110 does not otherwise want performed.

In an embodiment, the task selection sub-system 206 monitors, in real-time, the different interfaces corresponding to the recommended projects and/or tasks (e.g., the project interface 122 described above in connection with FIG. 1, etc.), including any corresponding communications sessions between the member 110 and the representative 104, to collect data with regard to member selection of projects and/or tasks for delegation to the representative 104 or third-party services and/or other services/entities affiliated with the task facilitation service for performance. For instance, the task selection sub-system 206 may process messages corresponding to projects and/or tasks presented to the member 110 by the representative 104 over the different interfaces corresponding to the recommended projects and/or tasks to determine a polarity or sentiment corresponding to each project and/or task. For example, if a member 110 indicates, in a message to the representative 104, that they would prefer not to receive any task or project recommendations corresponding to vehicle maintenance, the task selection sub-system 206 may ascribe a negative polarity or sentiment to projects and tasks corresponding to vehicle maintenance. Alternatively, if a member 110 selects a task or project related to gutter cleaning for delegation to the representative 104 and/or indicates in a message to the representative 104 that recommendation of this task or project was a great idea, the task selection sub-system 206 may ascribe a positive polarity or sentiment to this task or project. In an embodiment, the task selection sub-system 206 can use these responses to tasks and/or projects recommended to the member 110 to further train or reinforce the machine learning algorithm or artificial intelligence utilized by the task ranking sub-system 204 to generate project and task recommendations that can be presented to the member 110 and other similarly situated members of the task facilitation service. Further, the task selection sub-system 206 may update the member's profile or model to update the member's preferences and known behavior characteristics based on the member's selection of projects and/or tasks from those recommended by the representative 104 and/or sentiment with regard to the projects and/or tasks recommended by the representative 104.

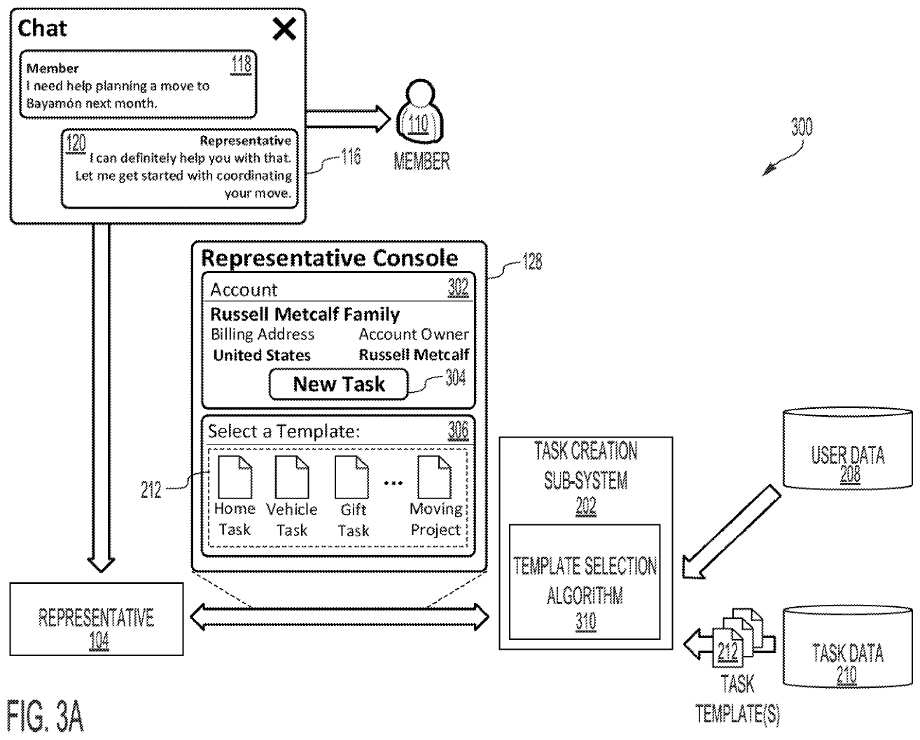

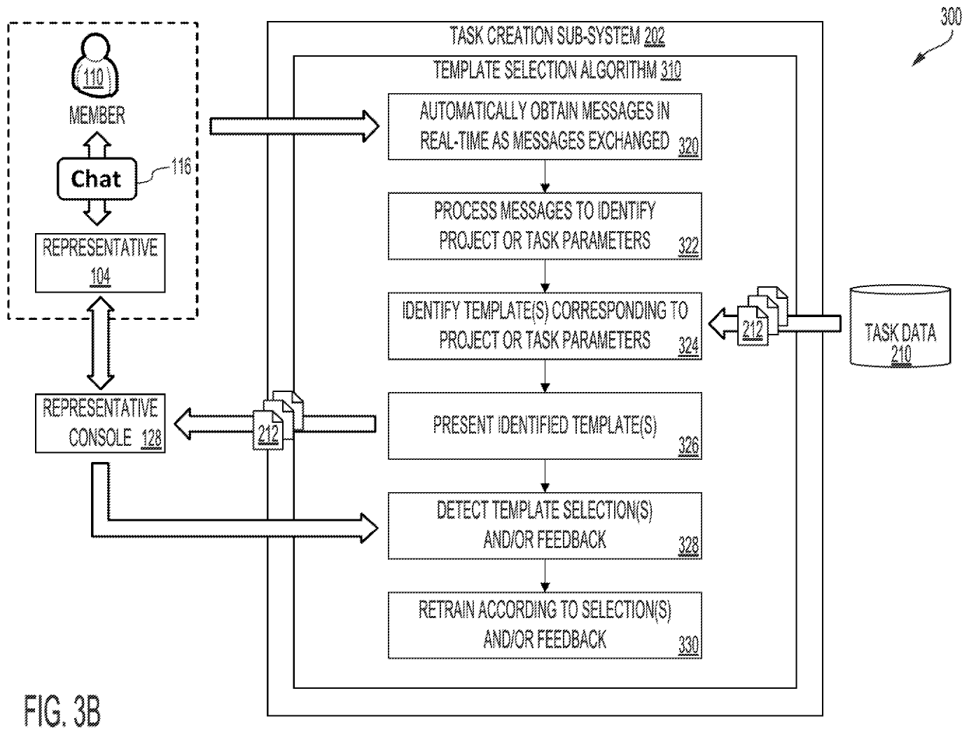

FIGS. 3A-3B show an illustrative example of an environment 300 in which a representative 104, via a representative console 128, is provided with one or more templates 212 that can be selected to define a new project or task on behalf of a member 110 in accordance with at least one embodiment. In the environment 300, a representative 104 can submit a request to the task creation sub-system 202 to generate a new project or task. As noted above, a representative 104 may be engaged with a member 110 over a communications session 116. Through this communications session 116, a member 110 may indicate that they require assistance with regard to a particular issue. For example, as illustrated in FIG. 3A, the member 110 has submitted a message 118 to the representative 104 over the communications session 116, whereby the member 110 indicates that they require assistance in planning a move to Bayamon (e.g., a new city) over the coming month. In response to the message 118, the representative 104 may determine that the member 110 has expressed an issue for which one or more projects and/or tasks may be created to address the issue on behalf of the member 110. Thus, in response to the message 118 (as illustrated in FIG. 3A), the representative 104 may submit, over the communications session 116, a message 120 to indicate that the representative 104 is able to assist the member 110 in addressing their specified issue.

In an embodiment, once the representative 104 has identified, based on messages 118 from the member 110, that a new project or task is to be created to address a specified issue, the representative 104 can submit a request to the task creation sub-system 202 to create a new project or task that may be performed for the benefit of the member 110. As noted above, the representative 104 may interact with the task facilitation service and, particularly, with the task creation sub-system 202 via a representative console 128 provided by the task facilitation service. Through the representative console 128, the task creation sub-system 202 may provide an account window 302, through which the representative 104 may review account information associated with the member 110 and submit a request to create a new project or task that may be performed for the benefit of the member 110. For instance, the account window 302 may include an account name (e.g., unique label associated with the account as defined by the member 110, the representative 104, or by the task facilitation service based on characteristics of the account, etc.), a phone number associated with the account, a billing address or other address associated with the account, a website associated with the account, an account holder's name (e.g., the member 110 or other entity that serves as the owner of the account), and the like. This information may be used to uniquely identify the account for the representative 104.

The information provided via the account window 302 may be obtained from the member profile associated with the member 110 and maintained in the user datastore 208. As noted above, a member 110 may be assigned a representative 104 during an onboarding process. If each representative 104 is only associated with an individual member 110 of the task facilitation service, the task creation sub-system 202 may query the user datastore 208 using a unique identifier of the representative 104 to identify the member profile in the user datastore 208 that corresponds to the member 110 that the representative 104 is assigned to. Alternatively, if the same representative 104 is assigned to multiple members of the task facilitation service, the task creation sub-system 202 may identify a unique identifier corresponding to the communications session 116 between the representative 104 and the member 110. For example, when a new communications session 116 is established between a representative 104 and a particular member 110, the task facilitation service can generate and assign a unique identifier to the new communications session 116. This unique identifier for the new communications session 116 may be associated with a member profile associated with the member 110 stored within the user datastore 208, whereby messages 118-120 exchanged over the communications session 116 are automatically entered and stored in association with the member profile. Thus, the task creation sub-system 202 may detect which communications session 116 the representative 104 is engaged in and obtain the unique identifier associated with the communications session 116 for use in identifying the member profile associated with the member 110 from the user datastore 208. In some instances, if the representative 104 is assigned to multiple members, the representative 104 may indicate which member 110 the representative 104 is communicating with via the representative console 128.

In an embodiment, the account window 302 can include a new task button 304, through which the representative 104 can submit a request to the task creation sub-system 202 to generate a new task or project for the member 110 represented in the account window 302. If the representative 104 selects the new task button 304, the task creation sub-system 202 may present, through a template selection window 306 of the representative console 128, one or more task templates 212. For instance, in response to a selection of the new task button 304, the task creation sub-system 202 may identify, from the task datastore 210, one or more task templates 212 that may be available for use in defining new projects and tasks. As noted above, each template 212 may include different data fields for defining a project or task, whereby the different project or task fields may correspond to the project/task type or category for the project or task being defined. The representative 104, via a template, may provide information related to the issue that is to be addressed via these different fields to define the project or task that may be submitted to the task creation sub-system 202 for processing.

In an embodiment, if the representative 104 selects the new task button 304 from the representative console 128, the task creation sub-system 202 updates the template selection window 306 of the representative console 128 to present a resource library interface associated with the resource library maintained by the task facilitation service. As noted above, the resource library may serve as a repository for different project and task generation templates. Each template may be associated with one or more keywords or anchor terms that may be used to denote the project or task type or category for the template. Thus, through the resource library interface presented via the template selection window 306, the representative may enter one or more keywords or anchor terms that may be used in a query to the resource library to identify any templates 212 corresponding to the one or more keywords or anchor terms. The task creation sub-system 202 may update the template selection window 306 to present the one or more templates 212 returned from the resource library in response to the query submitted by the representative 104 through the resource library interface.

If the representative 104 selects a particular template from the one or more templates 212 presented via the template selection window 306, the task creation sub-system 202 may automatically update the representative console 128 to present the selected template. The template, as noted above, may include a set of data fields through which the representative 104 may define the new project or task that may be performed for the benefit of the member 110 and to address the issue specified by the member 110 via the communications session 116. As noted above, once the representative 104 has defined a new project or task using the selected template, the task recommendation system can provide the one or more new projects and/or tasks, along with the member's existing or pending projects and/or tasks, to the representative 104 to allow the representative 104 to evaluate these projects and/or tasks and determine which projects and/or tasks to present to the member 110. Thus, once the representative 104 has utilized a template from the one or more templates 212 presented via the template selection window 306 to create a new project or task, the task recommendation system can rank all of the projects and/or tasks (new and/or pending) based on a likelihood of the member 110 selecting the project and/or task for delegation to the representative 104 for performance and/or coordination with third-party services 114. Alternatively, the task recommendation system may rank the projects and/or tasks based on the level of urgency for completion of each project and/or task.

In an embodiment, the representative 104 can forego selection of a template from the one or more templates 212 and instead define a new project or task using a default template. A default template may include various generic data fields for defining a new project or task. For instance, the default template may include data fields that may be used to define a name for the new project or task, a deadline for completion of the new project or task, a budget for completion of the new project or task, a priority for the new project or task, and a short description of the new project or task. Further, the default template may include various options for the representative 104 to add new data fields to the template that may be specific to the new project or task. The representative 104, in some instances, may store or otherwise make available, through the resource library, this custom template for use by other representatives of the task facilitation service for similar projects or tasks. This custom template may be assigned one or more keywords or other anchor terms/phrases that may be used to identify the custom template for creation of similar projects or tasks. The task creation sub-system 202 may store this new custom template within the task datastore 210, which may serve as a repository for the resource library. Thus, if another representative submits a request to generate a new project or task that may be performed on behalf of another member, the task creation sub-system 202 may provide, with the one or more templates 212, the new custom template from the resource library.

In an embodiment, the task creation sub-system 202 implements a template selection algorithm 310 that is dynamically trained to automatically select and present one or more templates 212 via the template selection window 306 based on the messages 118-120 exchanged over the communications session 116. The template selection algorithm 310 may be trained using supervised training techniques. For instance, a dataset of input messages, templates, and corresponding projects and tasks (and corresponding parameters) can be selected for training of the template selection algorithm 310. The template selection algorithm 310 may be evaluated to determine, based on the sample inputs supplied to the template selection algorithm 310, whether the template selection algorithm 310 is accurately identifying templates that may be provided to the representative 104 based on the supplied messages. Based on this evaluation, the template selection algorithm 310 may be modified to increase the likelihood of the machine learning algorithm or artificial intelligence to accurate identify templates corresponding to the sample messages provided as input.

As illustrated in FIG. 3B, the template selection algorithm 310, at step 320, may automatically obtain, in real-time, any messages 118-120 exchanged between the member 110 and the representative 104 as these messages are exchanged. For instance, the task creation sub-system 202 may maintain an active data stream or other connection between the communications session 116 and the template selection algorithm 310 such that, as messages 118-120 are exchanged over the communications session 116, the template selection algorithm 310 may automatically obtain these messages 118-120 in real-time.

At step 322, the template selection algorithm 310 may automatically process these exchanged messages 118-120 to identify a set of project or task parameters corresponding to the member's request. As described in greater detail herein, the template selection algorithm 310 may utilize NLP or other artificial intelligence to automatically, and in real-time, process the messages 118-120 exchanged over the communications session 116 as these messages 118-120 are exchanged to identify an issue expressed by the member 110 to the representative 104. This may include automatically identifying one or more anchor terms or phrases that may be representative of an issue expressed by the member 110. These one or more anchor terms may correspond to a member request for which a new project or task is to be defined, as well as to a set of parameters for this new project or task.

At step 324, the template selection algorithm 310 may identify one or more templates corresponding to the identified project or task parameters. For instance, the template selection algorithm 310, using the project or task parameters identified through processing of the exchanged messages 118-120, may automatically query the resource library maintained by the task facilitation service to identify one or more templates 212 that may be relevant to the new project or task that is to be created based on the identified issue. For instance, the template selection algorithm 310 may automatically query the resource library using the identified one or more anchor terms or phrases to identify the one or more templates 212 that correspond to these anchor terms or phrases. In response to the query, the resource library may evaluate the set of templates from the task datastore 210 to identify the one or more templates 212 corresponding to these keywords or anchor terms. In some instances, rather than submitting a query through the resource library, the template selection algorithm 310 may automatically, and in real-time, parse the set of templates from the task datastore 210 to identify the one or more templates 212 corresponding to the identified project or task parameters.

At step 326, the template selection algorithm 310 may automatically update the representative console 128 to present the identified one or more templates 212. As noted above, the one or more templates 212 may be presented to the representative 104 through a template selection window 306, as illustrated in FIG. 3A. Through the template selection window 306, the representative 104 may select a particular template from the one or more templates 212 identified by the template selection algorithm 310, upon which the task creation sub-system 202 may automatically update the representative console 128 to present the selected template, as described above. Alternatively, the representative 104 may forego selection of a template from the one or more templates 212 identified by the template selection algorithm 310 and instead define a new project or task using a default template.

In an embodiment, the template selection algorithm 310 may automatically, and in real-time, monitor representative interactions with the one or more templates 212 and/or with a default template for creation of a new project or task. Through this monitoring of representative interactions with the representative console 128, the template selection algorithm 310 may automatically detect any template selections and/or feedback corresponding to the selection and presentation of the one or more templates 212. These template selections and/or feedback may be used, at step 330, to dynamically, and in real-time, retrain the template selection algorithm 310. For instance, the template selection algorithm 310 may be dynamically trained based on the selection of a template from the one or more templates 212 presented via the template selection window 306 or the creation of a new template for a given issue. For example, when a representative 104 selects a template from the one or more templates 212 or creates a new template, and the representative 104 proceeds to generate a new project or task using the selected/created template, the task creation sub-system 202 may update the dataset used to train the template selection algorithm 310 to include the template used by the representative 104 to generate the new project or task, the new project or task itself, and the messages 118-120 exchanged between the representative 104 and the member 110 over the communications session 116. This updated dataset may be used to, at step 330, dynamically retrain the template selection algorithm 310 to improve the template recommendations provided by the template selection algorithm 310 for the creation of new projects and tasks. Thus, over time, the template selection algorithm 310 may more accurately select templates that may be presented to the representative 104 based on the particular issue expressed by the member 110, as well as the representative's own template preferences, and selections made by the representative and other representatives for similar issues.

As noted above, the template selection algorithm 310 used to identify the one or more templates 212 that may be presented through the template selection window 306 may be continuously trained in real-time based on template selections made by the representative 104 and other representatives, and on communications exchanged amongst the various members and representatives associated with the task facilitation service. For instance, the dynamic and real-time training of the template selection algorithm 310 described above may be performed in parallel for different projects or tasks associated with the member 110 and other members. For example, the task facilitation service may continuously process, in real-time, communications exchanged between different members and different representatives for different projects or tasks as these communications are exchanged to obtain feedback corresponding to the selection of templates for creation of new projects or tasks. As this feedback is obtained in real-time, the task facilitation service may continuously update the template selection algorithm 310 to ensure that the template selection algorithm 310 is providing accurate results (e.g., project and task templates). Additionally, the task facilitation service may continuously process, in real-time, representative selections of different templates for different projects and tasks as these selections are made to improve the template recommendations provided by the template selection algorithm 310 for the creation of new projects and tasks.

The templates 212 presented via the template selection window 306, in some instances, may be selected using one or more classical algorithms or processes. These one or more classical algorithms or processes may automatically, and in real-time, process communications between the member 110 and the representative 104 through the communications session 116 as these communications are exchanged. From these communications, the one or more classical algorithms or processes may automatically determine whether these communications include one or more anchor terms or phrases corresponding to an issue that the member 110 would like resolved. Using these anchor terms or phrases, the one or more classical algorithms may automatically query the resource library on behalf of the representative 104 to identify any available templates corresponding to these anchor terms or phrases. In response to this query, the one or more classical algorithms or processes may identify the one or more templates 212 corresponding to these anchor terms or phrases. The one or more classical algorithms or processes may further automatically update the template selection window 306 to present the identified templates 212.

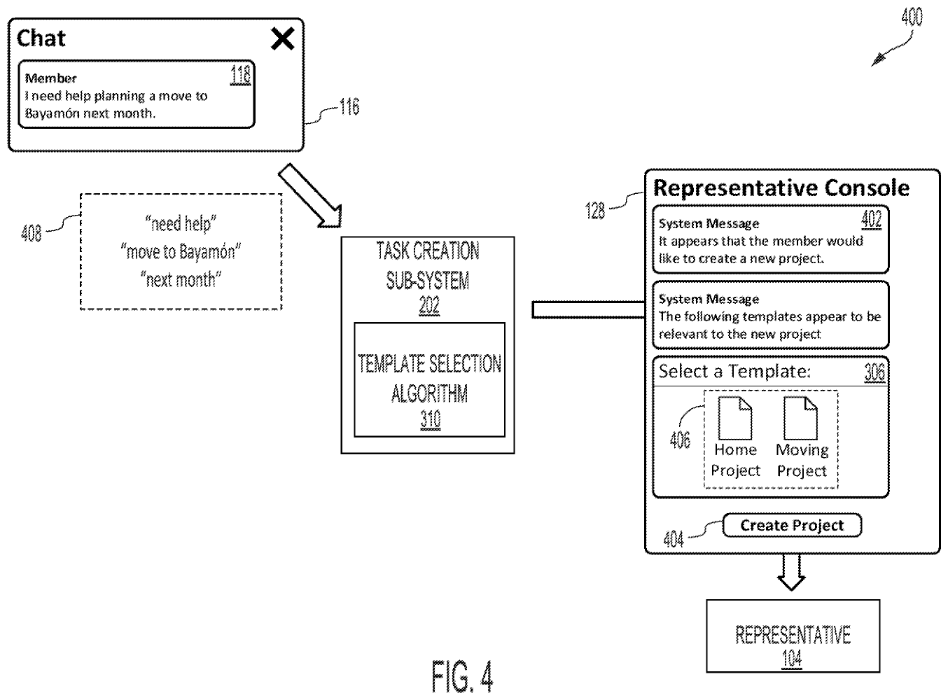

FIG. 4 shows an illustrative example of an environment 400 in which a task creation sub-system 202 dynamically identifies, in real-time, one or more templates 406 for creation of a new project or task based on messages 118 exchanged between a member and an assigned representative as these messages 118 are exchanged in accordance with at least one embodiment. As noted above, a member of the task facilitation service and an assigned representative 104 may exchange messages over a communications session 116 to address any issues expressed by the member. For instance, a member may transmit one or more messages 118 over the communications session 116 to express that the member requires assistance from the representative 104 to address a particular issue. As illustrated in FIG. 4, the member has expressed that they require assistance with planning an upcoming move to a new city, which is to take place in the coming month.

In an embodiment, the task creation sub-system 202 implements a template selection algorithm 310 that is trained to use NLP or other artificial intelligence to automatically, and in real-time, process messages exchanged over the communications session 116 as these messages are exchanged to identify an issue expressed by the member to the representative over the communications session 116. For instance, as illustrated in FIG. 4, the template selection algorithm 310 may process the message 118 using NLP or other artificial intelligence to identify one or more anchor terms or phrases 408 corresponding to a possible issue expressed by the member. For example, as illustrated in FIG. 4, the template selection algorithm 310 has automatically, and in real-time, identified the anchor phrases 408 “need help” “move to Bayamon” and “next month.” The anchor phrase “need help” may correspond to a request from the member for assistance with a particular issue. The anchor phrase “move to Bayamon” may correspond to the type or category of the new project or task that is to be created (e.g., “move to” may correspond to a moving category of project or task and “Bayamon” may correspond to the location that is to serve as the destination for the move). Additionally, the anchor phrase “next month” may correspond to a temporal limitation for the new project or task, whereby “next month” may denote a deadline for completion of the new project or task. Thus, based on the message 118 expressed by the member to request assistance with a particular issue, the template selection algorithm 310 may automatically determine that a new project or task is to be created to address the issue, as well as different templates 406 that may be used by the representative 104 for the new project or task.

As noted above, the templates maintained in the resource library for defining new projects and tasks are associated with particular keywords or anchor terms that may be used to identify appropriate templates for different project or task categories or types. For example, a template corresponding to vehicle maintenance projects and tasks may be associated with the keywords “vehicle,” “automobile,” “car,” “van,” “engine,” and the like. Accordingly, if the member indicates, via a message 118 to the representative 104 over the communications session 116, that the member would like assistance with replacing the engine on the member's car, the task creation sub-system 202, through the template selection algorithm 310, may use the keywords “engine” and “car” to identify, from the resource library, any templates corresponding to vehicle maintenance projects and tasks.

As noted above, the template selection algorithm 310 used by the task creation sub-system 202 to identify, from the resource library, the one or more templates 406 that may be presented to the representative 104 via the template selection window 306 of the representative console 128 based on the identified issue may be trained using supervised training techniques. For instance, a dataset of input messages, templates, and corresponding projects and tasks (and corresponding parameters) can be selected for training of the template selection algorithm 310. The template selection algorithm 310 may be evaluated to determine, based on the sample inputs supplied to the template selection algorithm 310, whether the template selection algorithm 310 is accurately identifying templates that may be provided to the representative 104 based on the supplied messages. Based on this evaluation, the template selection algorithm 310 may be modified to increase the likelihood of the template selection algorithm 310 to accurately identify templates corresponding to the sample messages provided as input. The template selection algorithm 310 may further be dynamically trained by soliciting feedback from representatives with regard to the identification of templates based on communications sessions between these members and representatives. For instance, if the task creation sub-system 202 determines that the template selection algorithm 310 has failed to identify an appropriate template for creation of a project or task that a member would have liked to have completed to address an issue, the task creation sub-system 202 may use this feedback, along with the corresponding messages submitted by the member identifying the issue and the template used by the representative 104 to define the project or task for addressing the issue, to retrain the template selection algorithm 310 to better identify templates based on similar messages from members.

As noted above, the template selection algorithm 310 used to identify, from the resource library and in real-time, one or more templates that may be provided to the representative 104 may be dynamically trained based on communications exchanged between the member and the representative 104 through the communications session 116 and/or through project- or task-specific communications sessions corresponding to the project or task (respectively) being performed for the benefit of the member. This dynamic training of the template selection algorithm 310 may be performed in real-time and as these communications are exchanged over the communications session 116 and/or through the project- or task-specific communications sessions corresponding to the project or task. Further, the template selection algorithm 310 may be continuously trained in real-time based on communications exchanged amongst the various members and representatives associated with the task facilitation service 102 for different projects and tasks. For instance, the dynamic and real-time training of the template selection algorithm 310 described above may be performed in parallel for different projects or tasks associated with the different members associated with the task facilitation service by continuously processing, in real-time, communications exchanged between different members and different representatives for different projects or tasks as these communications are exchanged. This processing of parallel communications in real-time as these communications are exchanged may result in the task creation sub-system 202 obtaining feedback corresponding to the selection of templates for creation of new projects or tasks. As this feedback is obtained in real-time, the task creation sub-system 202 may continuously update the template selection algorithm 310 to ensure that the template selection algorithm 310 is providing accurate results (e.g., project and task templates).

It should be noted that while machine learning algorithms and artificial intelligence systems, such as the template selection algorithm 310, are described extensively throughout the present disclosure for the purpose of illustration, other techniques may be used to identify, from the resource library, the one or more templates 406 that may be presented to the representative 104 via the template selection window 306 of the representative console 128. For example, as noted above, the task creation sub-system 202 may implement one or more classical algorithms or processes that may be used to automatically identify one or more templates that may be provided to the representative 104 for defining a new project or task. These one or more classical algorithms or processes may automatically, and in real-time, process communications between the member and the representative 104 through the communications session 116 as these communications are exchanged and automatically determine whether these communications include one or more anchor terms or phrases corresponding to an issue that the member would like resolved. Using these anchor terms or phrases (if detected), the one or more classical algorithms may automatically query the resource library to identify any available templates corresponding to these anchor terms or phrases. As noted above, each template may be associated with one or more keywords or anchor terms that may be used to denote the project or task type or category for the template. Thus, in response to this query, the one or more classical algorithms or processes may identify the one or more templates corresponding to these anchor terms or phrases. The one or more classical algorithms or processes may provide these identified templates 406 to the task creation sub-system 202, which may update the template selection window 306 of the representative console 128 to present these templates 406.

In an embodiment, if the task creation sub-system 202 identifies an issue expressed by the member to the representative 104 over the communications session 116, the task creation sub-system 202 can notify the representative 104 of the issue and present, via the representative console 128, different templates 406 that may be used by the representative 104 to generate a new project or task that may be performed for the benefit of the member to address the identified issue. For example, as illustrated in FIG. 4, the task creation sub-system 202 may transmit a message 402 to the representative 104 via the representative console 128 to indicate that the member has submitted a request to create a new project or task in order to address a particular issue. Further, via the template selection window 306 of the representative console 128, the task creation sub-system 202 may present one or more templates 406 that may correspond to the identified issue. Additionally, the task creation sub-system 202 may present, via the representative console 128, a task/project creation button 404, through which the representative 104 may request a default template that may be used to define a new project or task to address the issue expressed by the member. For instance, if the representative 104 does not identify an appropriate template from the templates 406 selected by the task creation sub-system 202 for defining the new project or task, the representative 104 may use the task/project creation button 404 to request creation of a new custom template for the new project or task.

A default template may include data fields that may be used to define a name for the new project or task, a deadline for completion of the new project or task, a budget for completion of the new project or task, a priority for the new project or task, and a short description of the new project or task. Further, the default template may include various options for the representative 104 to add new data fields to the template that may be specific to the new project or task. The representative 104, in some instances, may store or otherwise make available this custom template through the resource library for use by other representatives for similar projects or tasks. This custom template may be assigned one or more keywords or anchor terms/phrases that may be used to identify the custom template for creation of similar projects or tasks. For instance, the representative 104 may define one or more keywords or anchor terms/phrases that may be associated with the custom template. Alternatively, the task creation sub-system 202, using NLP or other artificial intelligence, may process the custom template to automatically identify the one or more keywords or anchor terms/phrases that may be assigned to the custom template. These one or more keywords or anchor terms/phrases may allow for identification of the custom template from the resource library through a query that includes any of the keywords and/or anchor terms/phrases associated with the custom template.

In an embodiment, if the representative 104 foregoes selection of a recommended template 406 from the template selection window 306 and, instead, creates a new custom template for creation of a new project or task associated with the identified issue, the task creation sub-system 202 may use this as feedback that may be used to retrain the template selection algorithm 310 utilized to recommend templates 406 that may be used to define new projects and tasks for a particular issue. For instance, the task creation sub-system 202 may use the new custom template generated by the representative 104, the messages 118 exchanged over the communications session 116 indicative of the issue for which the new project or task was generated, and the templates 406 rejected by the representative 104 as input to the template selection algorithm 310 to retrain the machine learning algorithm or artificial intelligence. This process may increase the likelihood of the template selection algorithm 310 selecting the new custom template generated by the representative 104 for similar issues and for similarly-situated members of the task facilitation service.

As noted above, the task creation sub-system 202 may automatically generate recommendations for questions that may be presented to the member regarding new projects or tasks generated by the representative 104. These recommendations may be generated based on the member's preferences as defined in the member profile associated with the particular member and/or from the communications exchanged between the member and the representative 104 through the communications session 116. The recommendations generated by the task creation sub-system 202 may be provided to the representative 104 via the representative console 128. For instance, when a representative 104 interacts with a particular task, the task creation sub-system 202, via the representative console 128, may provide these recommendations to the representative 104. This may allow the representative 104 to readily determine what additional information may be required from the member in order to complete definition of a project and corresponding tasks through the selected template.

In an embodiment, in addition to updating a representative console 128 utilized by the representative 104 to provide one or more templates 406 that may be used to define a new project or task, the task creation sub-system 202 can automatically facilitate a new communications session between the member and the representative 104 that is specific to the new project or task created for the member. For example, through the application or web portal provided by the task facilitation service to a member of the task facilitation service, the task creation sub-system 202 may generate a new project- or task-specific interface corresponding to the newly created project or task. Through this new interface, the task creation sub-system 202 may facilitate a new communications session between the member and the representative 104, through which the representative 104 may communicate with the member with regard to the newly created project or task. For instance, through this new communications session, the representative 104 may communicate with the member to obtain any additional information that may be required from the member in order to complete definition of a project and corresponding tasks. Further, through this new communications session, the representative 104 may provide any proposals associated with the newly created project or task and allow the member to select a proposal for performance of the newly created project or task.

In some instances, the task creation sub-system 202 may further update the project-specific interface generated for the newly identified project to present any tasks associated with the newly created project. If the member selects any of these tasks through the project-specific interface, the task facilitation service may update the project-specific interface to provide a task-specific interface corresponding to the selected task. Through this task-specific interface, the member may communicate with the representative 104 through a task-specific communications session facilitated between the member and the representative 104 and through which the member and the representative 104 may communicate with one another concerning the selected new task. Further, through this task-specific interface, the member may provide any additional information that may be used by the representative 104 and/or any third-party service or other service/entity affiliated with the task facilitation service and assigned to the new task in completing the task on behalf of the member.

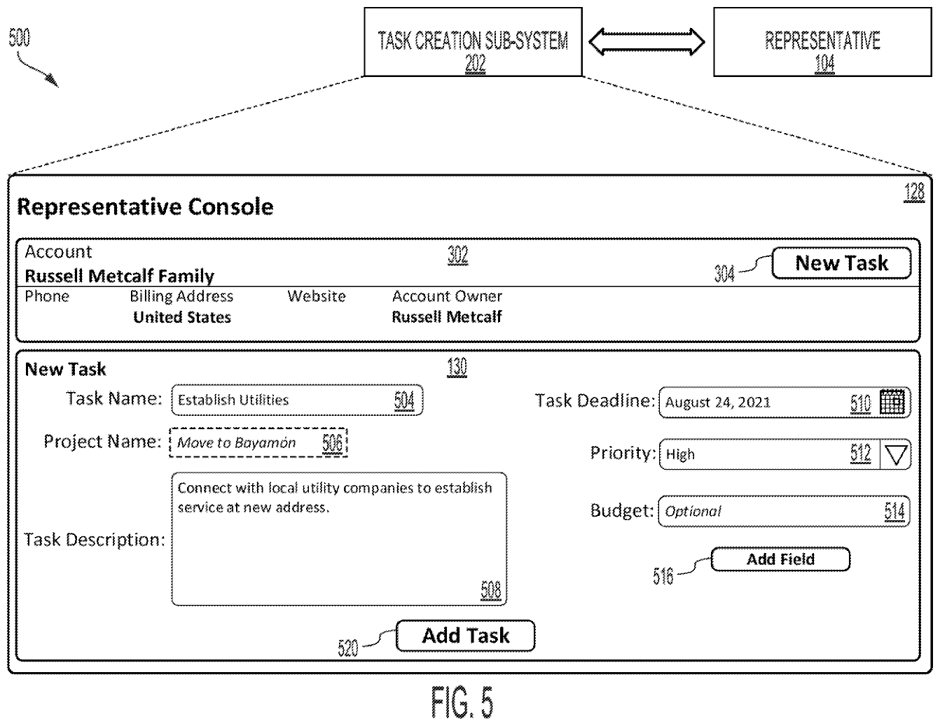

FIG. 5 shows an illustrative example of an environment 500 in which a task creation sub-system 202 provides, via a representative console 128, a task creation window 130 through which a task template is presented for the creation of a new task to be performed for the benefit of a member in accordance with at least one embodiment. As noted above, the task creation sub-system 202 may maintain, in a task datastore, project and task templates for different project/task types or categories. Each project or task template may include different data fields for defining the project or task, whereby the different project or task fields may correspond to the project/task type or category for the project or task being defined. The representative 104 and/or the member may provide information related to the issue that is to be addressed via these different fields to define the project or task that may be submitted to the task creation sub-system 202 for processing.

As illustrated in FIG. 5, the task creation sub-system 202, via the representative console 128, may provide an account window 302, through which the representative 104 may review account information associated with the member and submit a request to create a new task or project for the member. For instance, the account window 302 may include an account name (e.g., unique label associated with the account as defined by the member, the representative 104, or by the task facilitation service based on characteristics of the account, etc.), a phone number associated with the account, a billing address or other address associated with the account, a website associated with the account, an account holder's name (e.g., the member or other entity that serves as the owner of the account), and the like. This information may be used to uniquely identify the account associated with the member for the benefit of the representative 104.

In an embodiment, the account window 302 can include a new task button 304, through which the representative 104 can submit a request to the task creation sub-system 202 to generate a new task or project for the member represented in the account window 302. If the representative 104 selects the new task button 304, the task creation sub-system 202 may present a task template via a task creation window 130. The initial task template provided via the task creation window 130 may be a generic or universal task template that may be used to define any number of different task or project parameters for a new task or project, respectively. For instance, as illustrated in FIG. 5, the task creation sub-system 202 may present a task name field 504, through which the representative 104 may enter or define a name for the new task. Additionally, the task creation sub-system 202 may provide a project name field 506, which may specify the name of the project for which the task is being generated (if a task rather than a project is being defined). If a project is being defined via the representative console 128, the project name field 506 may be omitted.

The task creation sub-system 202 may further provide, via the task creation window 130, a task description field 508, through which the representative 104 may provide a short description of the new task or project being generated for the member. In an embodiment, once the representative 104 has provided a name and short description for the project or task, the task creation sub-system 202, using a machine learning algorithm or artificial intelligence, may use the provided name and short description, as well as historical data corresponding to the member and similarly situated members (e.g., previous projects and/or tasks created for the member and similarly situated members, etc.), as input to select, from the resource library, a particular task template that may be presented to the representative 104 via the task creation window 130. For example, if the representative 104 provides a task name corresponding to a task for establishing utilities in a new town and provides, as a short description, that the task is for connecting with local utility companies to establish service at a new address, the task creation sub-system 202, using the machine learning algorithm or artificial intelligence, may identify, from the resource library, a task template corresponding to moving or utility tasks. Accordingly, the task creation sub-system 202 may update the task creation window 130 automatically to present one or more data fields corresponding to the identified task template and import the previously provided information into any applicable data fields of the identified template. Thus, based on the identified task category or type, the representative 104 may be presented with relevant data fields for defining the task.

In an embodiment, the task creation sub-system 202 can automatically provide a task template via the task creation window 130 for an issue automatically identified from the messages exchanged between the member and the representative 104 over the communications session between the member and the representative 104. For instance, if the task creation sub-system 202 identifies a new issue based on the messages exchanged between the member and the representative 104, the task creation sub-system 202 may automatically identify, from the resource library, one or more templates that may be used to generate a new task or project. If the representative 104 selects a particular template identified by the task creation sub-system 202 or a default template, the task creation sub-system 202 may automatically populate any applicable data fields associated with the template for the new task or project based on information gleaned from these messages.

As noted above, if the task creation sub-system 202 identifies an issue that the member would like to have addressed based on the messages exchanged between the member and the representative 104, the task creation sub-system 202 may automatically notify the representative 104 of this new issue. This notification may be provided through the representative console 128, through which the representative 104 may review the identified templates or submit a request to generate a project or task using a default template, as illustrated in FIG. 4. Further, through the task creation window 130, the representative 104 may make any changes to an identified template based on their knowledge of the member and/or of the issue that the member wishes to have resolved. Any modification to a pre-existing template presented via the task creation window 130 may be noted by the task creation sub-system 202 for further training of a machine learning algorithm or artificial intelligence used to automatically recommend different templates that may be used to generate projects and tasks based on issues specified by members. If the representative 104 modifies a pre-existing template, the task creation sub-system 202 may further store this modified template as a new template within the resource library, as described above.

Returning to the creation of a new task or project via the task creation window 130, the task creation sub-system 202 may further provide a task deadline field 510, through which the representative 104 may define a deadline for completion of the task or project. In some instances, this task deadline field 510 may be automatically updated by the task creation sub-system 202 based on the messages exchanged between the member and the representative 104. Using the illustrative example described above in connection with FIGS. 1, 3, and 4 related to an upcoming move to Bayamón, the task creation sub-system 202 may use NLP or other artificial intelligence to process the messages exchanged between the member and the representative 104 to determine that the deadline for the upcoming move is in the next month. Accordingly, the task creation sub-system 202 may automatically calculate, based on this identified statement from the member, a corresponding deadline for the project. Accordingly, the task creation sub-system 202 may automatically update the task deadline field 510 to indicate this calculated deadline. The representative 104, based on their own knowledge of the member and of the project or task specified by the member, may modify this original deadline through the task deadline field 510 if necessary.

The task creation sub-system 202 may further provide, via the task creation window 130, a priority field 512, through which a priority may be assigned for the particular task or project. For instance, if the representative 104 determines, based on their knowledge of the member and of the task or project, that the member considers the particular project or task to be of utmost importance, the representative 104 may assign a high priority to the project or task via the priority field 512. Conversely, if the representative 104 determines that the project or task is not an urgent one and is one that can be performed at any time without any negative impact to the member, the representative 104 may assign a lower priority to the project or task via the priority field 512. This assignment of a priority may be used by the task recommendation system as a factor in ranking the various tasks and projects identified by the representative 104 and/or task recommendation system for the member.

In an embodiment, the task creation sub-system 202 can automatically assign a priority to the task or project via the priority field 512 based on the messages corresponding to the project or task exchanged between the member and the representative. For instance, using NLP or other artificial intelligence, if the task creation sub-system 202 identifies a level of urgency on the part of the member for addressing a particular issue, the task creation sub-system 202 may ascribe a high level of urgency and, thus, a high priority for the project or task. Indicators of urgency may include semantic and non-semantic characteristics of the messages exchanged between the member and the representative 104. For instance, if the member uses anchor terms indicative of an urgent need for completion of a task or project (e.g., “now,” “immediately,” “as soon as possible,” “ASAP,” etc.), the task creation sub-system 202 may determine that there is a high level or urgency in having the task or project completed quickly. Additionally, if the member's typing frequency is elevated, the member is making more frequent typographical errors, the member is using exclamatory symbols, etc., the task creation sub-system 202 may use these as indicators of a high level of urgency for completion of the task or project. Accordingly, the task creation sub-system 202 may update the priority field 512 to indicate a high priority for completion of the identified task or project.

The task creation sub-system 202, via the task creation window 130, may further provide a budget field 514, through which a budget for completion of the task or project may be defined. For instance, the representative 104, based on their knowledge of the member and of the particular task or project being created, may define a budget for completion of the task or project via the budget field 514. In some instances, if the representative 104 knows that the member is not budget conscious with regard to performance of projects and tasks, the representative 104 may omit providing a budget via the budget field 514. Thus, the definition of a budget via the budget field 514 may be optional, as illustrated in FIG. 5. In an embodiment, the task creation sub-system 202 can automatically define a budget for the task or project based on an evaluation of the member's profile and of similar tasks or projects previously performed for similarly situated members of the task facilitation service. For instance, if the member is not budget conscious but, based on similar tasks or projects previously performed for similarly situated members, the task creation sub-system 202 determines an average estimated cost for completion of the project or task, the task creation sub-system 202 may define a budget via the budget field 514 that corresponds to this average estimated cost. In some instances, if the task creation sub-system 202 determines, based on an evaluation of the member's profile, that the member is not budget conscious, the task creation sub-system 202 may omit the budget field 514 entirely from the task creation window 130.

The task creation window 130 may further include an add field button 516, which the representative 104 may utilize to add one or more data fields to the template for the task or project to further define additional parameters for the new task or project. As an illustrative example, if the representative 104 determines that the member is concerned with regard to what brands or services are used for performance of their tasks, the representative 104 may add one or more data fields corresponding to selection or identification of brands or services for performance of the task or project. As another illustrative example, if the representative 104 knows that the member is interested in ratings related to brands or services used for the performance of the task or project, the representative 104 may add a data field for the task or project corresponding to brand or service ratings that may be presented to the member.

The data fields presented in a template for a project or task can be selected based on a determination generated using a machine learning algorithm or artificial intelligence. The task creation sub-system 202 can use, as input to the machine learning algorithm or artificial intelligence, a member profile from the user datastore and the selected template from the resource library to identify which data fields may be omitted from the template when presented to the representative 104 via the task creation window 130 for definition of a new task or project. For instance, if the member is known to delegate maintenance tasks to a representative 104 and is indifferent to budget considerations, the task creation sub-system 202 may present, to the representative 104, a task template that omits any budget-related data fields and other data fields that may define, with particularity, instructions for completion of the task.

Through use of the add field button 516 and through other interface elements associated with optional fields presented via the task creation window 130, the task creation sub-system 202 may allow the representative 104 to add, remove, and/or modify the data fields for the template. For example, if the task creation sub-system 202 removes a data field corresponding to the budget for the task based on an evaluation of the member profile, the representative 104 may use the add field button 516 to request that the data field be added to the template to allow the representative 104 to define a budget for the task based on their knowledge of the member. The task creation sub-system 202, in some instances, may utilize this change to the template to retrain the machine learning algorithm or artificial intelligence to improve the likelihood of providing templates to the representative 104 via the task creation window 130 without need for the representative 104 to make any modifications to the template for defining a new project or task.

Once the new project or task has been defined via the task creation window 130, the representative 104 may select an add task button 520 provided via the task creation window 130 to submit the newly created task or project. The task creation sub-system 202 may add the new project or task to the listing of tasks or projects that are to be performed for the benefit of the member. Further, the newly created task or project may be ranked according to a likelihood of the member selecting the task or project for delegation to the representative 104 for performance and coordination with third-party services. Alternatively, the new task or project may be ranked based on the level of urgency for completion of each project or task. The level of urgency may be determined based on member characteristics from the user datastore (e.g., data corresponding to a member's own prioritization of certain tasks or categories of tasks) and/or potential risks to the member if the task or project is not performed.

In an embodiment, selection of the add task button 520 causes the task creation sub-system 202 to update the interface generated for the corresponding project or task to include the information defined by the representative 104 and/or by the task creation sub-system 202 through the task creation window 130. As noted above, if the task creation sub-system 202 identifies a project or task that may be performed in order to address an issue expressed by the member over the original communications session facilitated between the member and the representative 104, the task creation sub-system 202 may automatically generate a new interface for the newly identified project or task. Through this new interface, the task creation sub-system 202 may facilitate a communications session that is specific to the identified project or task. Further, in response to selection of the add task button 520, the task creation sub-system 202 may automatically update this interface to provide any updated information related to the identified project or task and provided by the representative 104 or otherwise identified by the task creation sub-system 202 and defined through the task creation window 130.

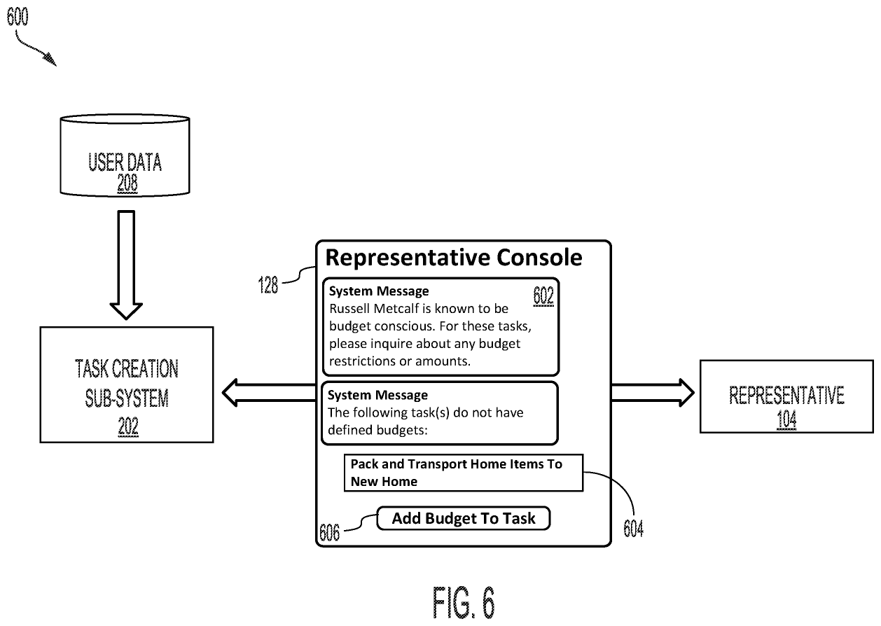

FIG. 6 shows an illustrative example of an environment 600 in which a task creation sub-system 202 automatically identifies additional information that is required from a member for defining new projects and tasks in accordance with at least one embodiment. In the environment 600, the task creation sub-system 202 may automatically, and in real-time, identify any additional information that may be required from a member for a particular project or task. As noted above, the task creation sub-system 202 may process a newly generated project and/or task and information corresponding to the member using a machine learning algorithm or artificial intelligence to automatically identify additional parameters for the project or task, as well as any additional information that may be required from the member for the generation of proposals associated with the project or task. For instance, the task creation sub-system 202 may use the generated project or task, information corresponding to the member, and historical data corresponding to projects and/or tasks performed for other similarly-situated members as input to the machine learning algorithm or artificial intelligence to identify any additional information that may be required of the member for defining the project and/or task. The task creation sub-system 202 may obtain the historical data corresponding to the projects and/or tasks performed for other similarly-situated members and information corresponding to the member from a user datastore 208. In some instances, the task creation sub-system 202 may use information from the user datastore 208 to identify the projects and/or tasks previously performed for other similarly-situated members and for the member itself. Once the task creation sub-system 202 has identified these projects and/or tasks, the task creation sub-system 202 may access a task datastore, such as task datastore 210 described above, to obtain these projects and/or tasks for use as input in the machine learning algorithm or artificial intelligence.

If the task creation sub-system 202 determines that additional member input is required for the newly generated project or task, the task creation sub-system 202 may provide the representative 104 with recommendations for questions that may be presented to the member regarding the project or task. For example, via a representative console 128 provided to the representative 104 by the task facilitation service, the task creation sub-system 202 may transmit one or more messages to the representative 104 indicating what additional information may be required from the member for the newly generated project or task. Returning to the “Move to Bayamon” project example illustrated in FIG. 1, if the task creation sub-system 202 determines that it is important to understand one or more parameters of the member's home (e.g., square footage, number of rooms, etc.) for the project, the task creation sub-system 202 may transmit a message to the representative 104 via the representative console 128 to provide a recommendation to the representative 104 to prompt the member to provide these one or more parameters. The representative 104 may review the recommendations provided by the task creation sub-system 202 and, via the communications session established between the member and the representative 104 for the particular project, prompt the member to provide the additional project parameters.

In an embodiment, the task creation sub-system 202 can further provide the representative 104, via the representative console 128, with recommendations for questions that may be presented to the member regarding the project or task based on the member's preferences. For example, if the member is known to be budget conscious, and the representative 104 and/or the task creation sub-system 202 has not defined any budgets or budget restrictions for the task or project, the task creation sub-system 202 may prompt the representative 104, via the representative console 128, to communicate with the member via the communications session established between the member and the representative 104 for the particular task or project to inquire about the member's budget for completion of the project or task. For example, as illustrated in FIG. 6, the task creation sub-system 202 may transmit a message 602 to the representative 104 indicating that the member is known to be budget conscious and, as such, the representative 104 should inquire about any budget restrictions or amounts for the newly generated project or task. Further, through the representative console 128, the task creation sub-system 202 may specify which tasks 604 have been newly generated but are missing the additional information identified by the task creation sub-system 202 as being important for these tasks 604 based on the member's preferences (as defined and identified via the member's profile and/or through evaluation of preferences for similarly-situated members).

As noted above, the task creation sub-system 202 can use a machine learning algorithm or artificial intelligence to determine what questions may be provided to the member. For instance, the task creation sub-system 202 may use the parameters defined for the new project or task, the member's profile, and historical data corresponding to projects and/or tasks previously performed for the benefit of the member as input to the machine learning algorithm or artificial intelligence to determine the member's preferences and to identify questions that may be provided to the member based on these preferences to further define the parameters of the new project or task. Based on the output of this machine learning algorithm or artificial intelligence, the task creation sub-system 202 may transmit one or more messages 602 to the representative 104 providing recommendations with regard to questions that may be provided to the member to further define the newly generated projects and/or tasks.

In an embodiment, through the representative console 128, the task creation sub-system 202 can provide an add information button 606 that may be selected to access the template corresponding to the identified tasks and/or projects for which additional information may be required. The add information button 606 may be specific to the particular information that needs to be added for the identified tasks and/or projects. For example, as illustrated in FIG. 6, the task creation sub-system 202 has provided an add information button 606 that is specific to defining a budget for the identified task 604 presented in the representative console 128. If the representative 104 selects the add information button 606, the task creation sub-system 202 may present, via the representative console 128, the template corresponding to the task 604 specified in the representative console 128. If multiple tasks or projects are presented via the representative console 128, selection of the add information button 606 may cause the task creation sub-system 202 to present the representative 104 with an option to select which task or project the representative 104 would like to amend to provide the additional information. In some instances, instead of presenting the template for a corresponding task or project via the representative console 128 in response to selection of the add information button 606, the task creation sub-system 202 may prompt the representative 104 to provide the additional information via the representative console 128. If the representative 104 provides this information to the task creation sub-system 202, the task creation sub-system 202 may automatically update the template corresponding to the task or project to input this additional information for the task or project.

It should be noted that in some instances, rather than prompting the representative 104 to obtain additional information that may be pertinent to the member for the newly generated tasks and/or projects, the task creation sub-system 202 may automatically communicate directly with the member via the communications session previously established between the member and the representative 104 for the particular project or task. For instance, the task creation sub-system 202 may automatically communicate with the member to obtain any additional information required for new projects and tasks and automatically generate proposals that may be presented to the member for performance of these projects and tasks. The representative 104 may monitor communications between the task creation sub-system 202 and the member to ensure that the conversation maintains a positive polarity (e.g., the member is satisfied with their interaction with the task creation sub-system 202 or other bot, etc.). If the representative 104 determines that the conversation has a negative polarity (e.g., the member is expressing frustration, the task creation sub-system 202 or bot is unable to process the member's responses or asks, etc.), the representative 104 may intervene in the conversation.

In an embodiment, the representative 104 or member can indicate that the additional information identified by the task creation sub-system 202 is not required for one or more newly generated projects and/or tasks. For instance, via the representative console 128, the representative 104 may indicate that, based on their knowledge of the member and/or in response to the member indicating that the additional information is not required, the additional information identified by the task creation sub-system 202 is not required for one or more newly generated projects and/or tasks. Accordingly, the task creation sub-system 202 may update the template for each project and/or task to omit this additional information and finalize creation of the new projects and/or tasks. Further, based on this feedback from the representative 104 or member, the task creation sub-system 202 may update the machine learning algorithm or artificial intelligence used to identify what additional information may be required for new projects and tasks to decrease the likelihood of similar prompts for additional information being presented to the representative 104 or member by the task creation sub-system 202 for similar projects and/or tasks and for similarly-situated members. For example, if a member indicates that they are not concerned with budgets for tasks and projects related to vehicle maintenance, and the task creation sub-system 202 previously determined that the member should be prompted with regard to budgets for tasks and projects related to vehicle maintenance, the task creation sub-system 202 may automatically update the machine learning algorithm or artificial intelligence used to determine what additional information may be required for these projects and tasks to reduce the likelihood of the task creation sub-system 202 prompting the representative 104 or member for additional information related to budgets for similar projects or tasks related to vehicle maintenance.

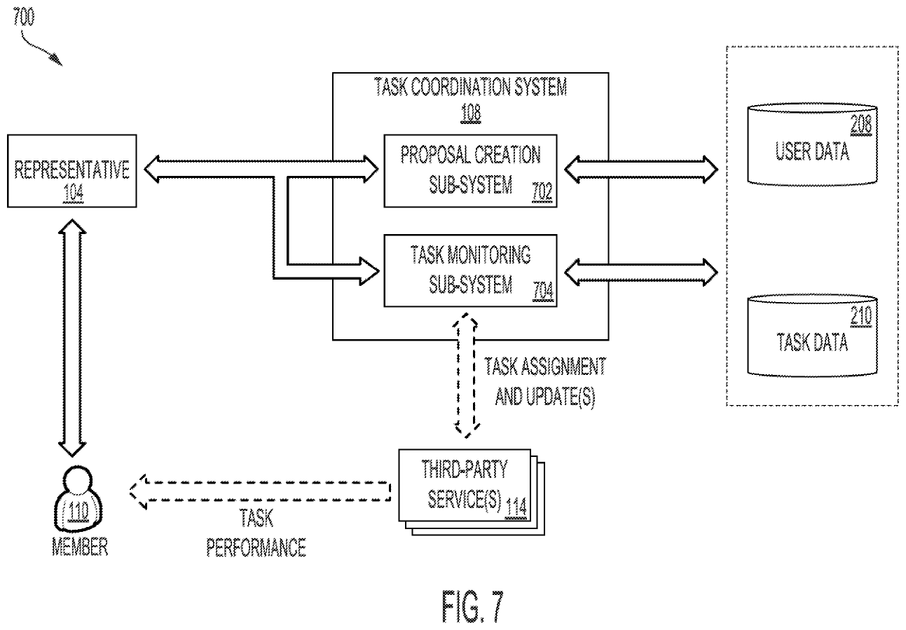

FIG. 7 shows an illustrative example of an environment 700 in which a task coordination system 108 assigns and monitors performance of a task for the benefit of a member 110 by a representative 104 and/or one or more third-party services 114 in accordance with at least one embodiment. In the environment 700, a representative 104 may access a proposal creation sub-system 702 of the task coordination system 108 to generate a proposal for completion of a project or task for the benefit of the member 110. The proposal creation sub-system 702 may be implemented using a computer system or as an application or other executable code implemented on a computer system of the task coordination system 108. Once the representative 104 has obtained the necessary project or task-related information from the member 110 and/or through the task recommendation system (e.g., task parameters garnered via evaluation of tasks performed for similarly situated members, etc.), the representative 104 can utilize the proposal creation sub-system 702 to generate one or more proposals for resolution of the project or task.

A proposal may include one or more options presented to a member 110 that may be created and/or collected by a representative 104 while researching a given project or task. In some instances, a representative 104 may access, via the proposal creation sub-system 702, one or more templates that may be used to generate these one or more proposals. For example, the proposal creation sub-system 702 may maintain, within the task datastore 210 or internally, proposal templates for different project and task types, whereby a proposal template for a particular project or task type may include various data fields associated with the project or task type. The task datastore 210 may be associated with a resource library that maintains the various proposal templates for the creation of new proposals for completion of different projects and tasks.

In an embodiment, the data fields within a proposal template can be toggled on or off to provide a representative 104 with the ability to determine what information is presented to the member 110 in a proposal. The representative 104, based on their knowledge of the member's preferences, may toggle on or off any of these data fields within the template. For example, if the representative 104 has established a relationship with the member 110 whereby the representative 104, with high confidence, knows that the member trusts the representative 104 in selecting reputable businesses for their projects and tasks, the representative 104 may toggle off a data field corresponding to the ratings/reviews for corresponding businesses from the proposal template. Similarly, if the representative 104 knows that the member 110 is not interested in the location/address of a business for the purpose of the proposal, the representative 104 may toggle off the data field corresponding to the location/address for corresponding businesses from the proposal template. While certain data fields may be toggled off within the proposal template, the representative 104 may complete these data fields to provide additional information that may be used by the proposal creation sub-system 702 to supplement proposals maintained by the task coordination system 108 within the resource library.

In an embodiment, the proposal creation sub-system 702 utilizes a machine learning algorithm or artificial intelligence to generate recommendations for the representative 104 regarding data fields that may be presented to the member 110 in a proposal. The proposal creation sub-system 702 may use, as input to the machine learning algorithm or artificial intelligence, a member profile associated with the member 110 from the user datastore 208, historical task and project data for the member 110 from the task datastore 210, and information corresponding to the project or task for which a proposal is being generated (e.g., a project/task type or category, etc.). The output of the machine learning algorithm or artificial intelligence may specify which data fields of a proposal template should be toggled on or off. The proposal creation sub-system 702, in some instances, may preserve, for the representative 104, the option to toggle on these data fields in order to provide the representative 104 with the ability to present these data fields to the member 110 in a proposal. For example, if the proposal creation sub-system 702 has automatically toggled off a data field corresponding to the estimated cost for completion of a project or task, but the member 110 has expressed an interest in the possible cost involved, the representative 104 may toggle on the data field corresponding to the estimated cost.

Once the representative 104 has generated a new proposal for the member 110, the representative 104 may present the proposal and any corresponding proposal options to the member 110. Further, the proposal creation sub-system 702 may store the new proposal in the user datastore 208 in association with a member profile associated with the member 110. In some instances, when a proposal is presented to a member 110, the proposal creation sub-system 702 may automatically, and in real-time, monitor member interaction with the representative 104 and with the proposal to obtain data that may be used to further train the machine learning algorithm or artificial intelligence. For example, if a representative 104 presents a proposal without any ratings/reviews for a particular business based on the recommendation generated by the proposal creation sub-system 702, and the member 110 indicates (e.g., through messages to the representative 104, through selection of an option in the proposal to view ratings/reviews for the particular business, etc.) that they are interested in ratings/reviews for the particular business, the proposal creation sub-system 702 may utilize this feedback to further train the machine learning algorithm or artificial intelligence to increase the likelihood of recommending presentation of ratings/reviews for businesses selected for similar projects/tasks or project/task types.

As noted above, task coordination system 108 may maintain a resource library that may be used to automatically populate one or more data fields of a particular proposal template. The resource library may include entries corresponding to businesses and/or products previously used by representatives for proposals related to particular projects/tasks or project/task types or that are otherwise associated with particular projects/tasks or project/task types. For instance, when a representative 104 generates a proposal for a task related to repairing a roof near Lynnwood, Wash., the proposal creation sub-system 702 may obtain information associated with the roofer selected by the representative 104 for the task. The proposal creation sub-system 702 may generate an entry corresponding to the roofer in the resource library and associate this entry with “roof repair” and “Lynnwood, Wash.” Thus, if another representative receives a task corresponding to repairing a roof for a member located near Lynnwood, Wash., the other representative may query the resource library for roofers near Lynnwood, Wash. The resource library may return, in response to the query, an entry corresponding to the roofer previously selected by the representative 104. If the other representative selects this roofer, the proposal creation sub-system 702 may automatically populate the data fields of the proposal template with the information available for the roofer from the resource library.

The representative 104 can query the resource library to identify one or more third-party services and other services/entities affiliated with the task facilitation service from which to solicit quotes for completion of the project or task. For instance, for a newly created project or task, the representative 104 may transmit a job offer to these one or more third-party services 114 and other services/entities. Through an application or web portal provided by the task facilitation service, a third-party service or other service/entity may review the job offer and determine whether to submit a quote for completion of the project or task or to decline the job offer. If a third-party service or other service/entity opts to reject the job offer, the representative 104 may receive a notification indicating that the third-party service or other service/entity has declined the job offer. Alternatively, if a third-party service or other service/entity opts to bid to perform the project or task, the third-party service or other service/entity may submit a quote for completion of the project or task. The representative 104 may use any provided quotes from the third-party services 114 and/or other services/entities to generate different proposal options for completion of the project or task. These different proposal options may be presented as a proposal to the member 110 through the project- or task-specific interface corresponding to the particular project or task that is to be completed. If the member 110 selects a particular proposal option from the set of proposal options presented through the project- or task-specific interface, the representative 104 may transmit a notification to the third-party service or other service/entity that submitted the quote associated with the selected proposal option to indicate that it has been selected for completion of the project or task.

As noted above, the representative 104, via a proposal template, may generate additional proposal options for businesses and/or products that may be used for completion of a project or task. For instance, for a particular proposal, the representative 104 may generate a recommended option, which may correspond to the business or product that the representative 104 is recommending for completion of a task. Additionally, in order to provide the member 110 with additional options or choices, the representative 104 can generate additional options corresponding to other businesses or products that may complete the project or task. In some instances, if the representative 104 knows that the member 110 has delegated the decision-making with regard to completion of a project or task to the representative 104, the representative 104 may forego generation of additional proposal options outside of the recommended option. However, the representative 104 may still present, to the member 110, the selected proposal option for completion of the project or task in order to keep the member 110 informed about the status of the project or task.

Once the representative 104 has completed defining a proposal via use of a proposal template, the representative 104 may present the proposal to the member 110 through the communications session established between the member 110 and the representative 104 and/or through an application or web portal provided by the task facilitation service. In some instances, the representative 104 may transmit a notification to the member 110 to indicate that a proposal has been prepared for a particular project or task and that the proposal is ready for review via the application or web portal provided by the task facilitation service. The proposal presented to the member 110 may indicate the project or task for which the proposal was prepared, as well as an indication of the one or more options that are being provided to the member 110. For instance, the proposal may include links to the recommended proposal option and to the other options (if any) prepared by the representative 104 for the particular project or task. These links may allow the member 110 to navigate amongst the one or more options prepared by the representative 104 via the application or web portal. In some instances, the representative 104 may transmit the proposal to the member 110 via other communication channels, such as via e-mail, text message, and the like.

For each proposal option, the member 110 may be presented with information corresponding to the business or product selected by the representative 104 and corresponding to the data fields selected for presentation by the representative 104 via the proposal creation sub-system 702. In some instances, the member 110 may select what details or data fields associated with a particular proposal are presented via the application or web portal. For example, if the member 110 is presented with the estimated total for each proposal option and the member 110 is not interested in reviewing the estimated total for each proposal option, the member 110 may toggle off this particular data field from the proposal via the application or web portal. Alternatively, if the member 110 is interested in reviewing additional detail with regard to each proposal option (e.g., additional reviews, additional business or product information, etc.), the member 110 may request this additional detail to be presented via the proposal.

As noted above, based on member interaction with a provided proposal, the proposal creation sub-system 702 may further train a machine learning algorithm or artificial intelligence used to determine or recommend what information should be presented to the member 110 and to similarly-situated members for similar projects/tasks or project/task types. The proposal creation sub-system 702 may automatically, and in real-time, monitor or track member interaction with the proposal to determine the member's preferences regarding the information presented in the proposal for the particular project or task. Further, the proposal creation sub-system 702 may automatically, and in real-time, monitor or track any messages exchanged between the member 110 and the representative 104 related to the proposal to further identify the member's preferences. In some instances, the proposal creation sub-system 702 may solicit feedback from the member 110 with regard to proposals provided by the representative 104 to identify the member's preferences. This feedback and information garnered through member interaction with the representative 104 regarding the proposal and with the proposal itself may be used to retrain the machine learning algorithm or artificial intelligence to provide more accurate or improved recommendations for information that should be presented to the member 110 and to similarly situated members in proposals for similar projects/tasks or project/task types. The proposal creation sub-system 702 may further use the feedback and information garnered through member interaction with the representative 104 to update a member profile or model within the user datastore 208 for use in determining recommendations for information that should be presented to the member 110 in a proposal.

In some instances, each proposal presented to the member 110 may specify any costs associated with each proposal option. These costs may be presented in different formats based on the requirements of the associated task or project. For instance, if the proposal corresponds to performance of the task by a third-party service or other service/entity associated with the task facilitation service, the proposal may include a quote submitted by the third-party service or other service/entity in response to the job offer from the representative 104. The quote may indicate any costs associated with different aspects of the project or task, as well as any additional fees that may be required for performance of the project or task (e.g., taxes, material costs, etc.). If a member 110 accepts a particular proposal option for a task or project, the representative 104 may communicate with the member 110 to ensure that the member is consenting to payment of the presented costs and any associated taxes and fees for the particular proposal option. In some instances, if a proposal option is selected with a static payment amount, the member 110 may be notified by the representative 104 if the actual payment amount required for fulfillment of the proposal option exceeds a threshold percentage or amount over the originally presented static payment amount.

In an embodiment, if a member 110 accepts a proposal option from the presented proposal, the task coordination system 108 moves the project or task associated with the presented proposal to an executing state and the representative 104 can proceed to execute on the proposal according to the selected proposal option. For instance, the representative 104 may contact one or more third-party services 114 to coordinate performance of the project or task according to the parameters defined in the proposal accepted by the member 110. Alternatively, if the representative 104 is to perform the project or task for the benefit of the member 110, the representative 104 may begin performance of the project or task according to the parameters defined in the proposal accepted by the member 110.

In an embodiment, the representative 104 utilizes a task monitoring sub-system 704 of the task coordination system 108 to assist in the coordination of performance of the project or task according to the parameters defined in the proposal accepted by the member 110. The task monitoring sub-system 704 may be implemented using a computer system or as an application or other executable code implemented on a computer system of the task coordination system 108. If the coordination with a third-party service 114 may be performed automatically (e.g., third-party service 114 provides automated system for ordering, scheduling, payments, etc.), the task monitoring sub-system 704 may interact directly with the third-party service 114 to coordinate performance of the project or task according to the selected proposal option. The task monitoring sub-system 704 may provide any information from a third-party service 114 to the representative 104. The representative 104, in turn, may provide this information to the member 110 via the communications session between the member 110 and the representative 104 and/or through the application or web portal utilized by the member 110 to access the task facilitation service. Alternatively, the representative 104 may transmit the information to the member 110 via other communication methods (e.g., e-mail message, text message, etc.) to indicate that the third-party service 114 has initiated performance of the project or task according to the selected proposal option. If the project or task is to be performed by the representative 104 for the benefit of the member 110, the task monitoring sub-system 704 may monitor and interact with the representative 104 to coordinate performance of the project or task according to the parameters defined in the proposal option accepted by the member 110. For instance, the task monitoring sub-system 704 may provide the representative 104 with any resources (e.g., payment information, task information, preferred sources for purchases, etc.) that may be required for performance of the project or task.

In an embodiment, the task monitoring sub-system 704 can monitor performance of projects and tasks by the representative 104 and/or third-party services 114 for the benefit of the member 110. For instance, the task monitoring sub-system 704 may record any information provided by the third-party services 114 with regard to the timeframe for performance of the project or task, the cost associated with performance of the project or task, any status updates with regard to performance of the project or task, and the like. The task monitoring sub-system 704 may associate this information with a data record corresponding to the project or task being performed within the task datastore 210. Status updates provided by third-party services 114 may be provided automatically to the member 110 via the application or web portal provided by the task facilitation service and to the representative 104. Alternatively, the status updates may be provided to the representative 104, which may provide these status updates to the member 110 over the communications session established between the member 110 and the representative 104 for the particular project or task or through other communication methods. If the representative 104 is performing the project or task for the benefit of the member 110, the representative 104 may provide status updates with regard to their performance of the project or task to the member 110 via the communications session facilitated between the member 110 and the representative 104 and corresponding to the project or task or through the application or web portal provided by the task facilitation service. The task monitoring sub-system 704 may associate these status updates with a data record corresponding to the task being performed within the task datastore 210.

In some instances, the task monitoring sub-system 704 may allow the third-party service or other service/entity engaged in performing the task to communicate with the member 110 directly to provide status updates related to the task. For instance, the task monitoring sub-system 704 may facilitate a communications session between the member 110 and the third-party service or other service/entity through which the member 110 and the third-party service or other service/entity may exchange messages related to the project or task being performed. This communications session may be provided through the interface specific to the project or task such that the communications session is distinct from the general communications session between the member 110 and the representative 104 and from any other project- or task-related communications sessions between the member 110 and the representative 104. In some instances, the third-party service or other service/entity may be added to the existing project- or task-specific communications session between the member 110 and the representative 104. This may allow the member 110 and the representative 104 to actively engage the third-party service or other service/entity as the third-party service or other service/entity performs the assigned project or task.

Once a project or task has been completed, the member 110 may provide feedback with regard to the performance of the representative 104 and/or third-party services 114 that performed the project or task according to the proposal option selected by the member 110. For instance, the member 110 may exchange one or more messages with the representative 104 over the project- or task-specific communications session to indicate their feedback with regard to the completion of the project or task. In an embodiment, the task monitoring sub-system 704 provides the feedback to the proposal creation sub-system 702, which may use a machine learning algorithm or artificial intelligence to process feedback provided by the member 110 to improve the recommendations provided by the proposal creation sub-system 702 for proposal options, third-party services 114 that may perform projects and tasks, and/or processes that may be performed by a representative 104 and/or third-party services 114 for completion of similar projects and tasks. For instance, if the proposal creation sub-system 702 detects that the member 110 is unsatisfied with the result provided by a third-party service 114 for a particular project or task, the proposal creation sub-system 702 may utilize this feedback to further train the machine learning algorithm or artificial intelligence to reduce the likelihood of the third-party service 114 being recommended for similar projects or tasks and to similarly-situated members. As another example, if the proposal creation sub-system 702 detects that the member 110 is pleased with the result provided by a representative 104 for a particular project or task, the proposal creation sub-system 702 may utilize this feedback to further train the machine learning algorithm or artificial intelligence to reinforce the operations performed by representatives for similar projects and tasks and/or for similarly-situated members.

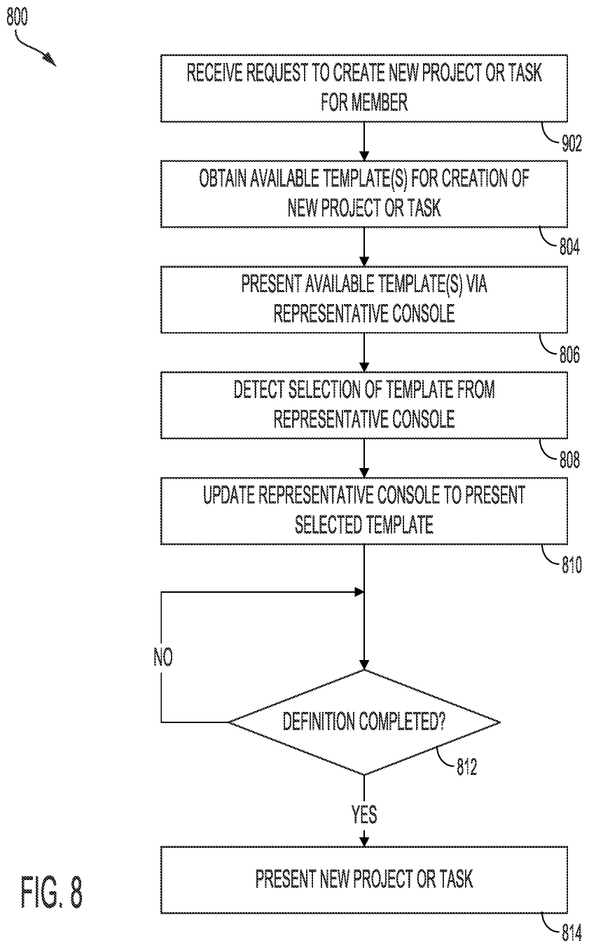

FIG. 8 shows an illustrative example of a process 800 for generating a new project or task based on data provided via a selected template in accordance with at least one embodiment. The process 800 may be performed by a task creation sub-system of the task recommendation system. As noted above, the task creation sub-system may maintain, within a resource library, a set of templates that may be used to generate new projects and tasks to be performed for the benefit of members of the task facilitation service.

At step 802, the task creation sub-system may receive a request to create a new project or task for a member of the task facilitation service. For instance, a representative assigned to a particular member may suggest one or more projects and/or tasks based on member characteristics, task history, and other factors. As the member communicates with the representative over the communications session, the representative may evaluate any messages from the member to identify any projects and/or tasks that may be performed to reduce the member's cognitive load. The representative, in response to messages from the member indicating an issue for which a new project or task may be created, may utilize a representative console provided by the task facilitation service to submit a request to the task creation sub-system to generate a new project or task.

At step 804, the task creation sub-system may obtain one or more available templates that may be used for creation of the new project or task. For instance, the task creation sub-system may query a resource library, as described above, to identify any available templates that may be used to create a new project or task. In an embodiment, the task creation sub-system can select and obtain, from the set of available templates, one or more templates that may be presented to the representative for the creation of a new project or task. For instance, in response to the request to create a new project or task, the task creation sub-system may utilize NLP or other artificial intelligence to automatically, and in real-time, process messages exchanged over the communications session between the representative and the member as these messages are exchanged to identify one or more parameters corresponding to an issue expressed by the member to the representative over the communications session 116. For example, the task creation sub-system may identify, from these messages, different anchor phrases or terms, which may correspond to a request from the member for assistance with a particular issue, the type or category of the new project or task that is to be created, and a temporal limitation for the new project or task. As noted above, the templates maintained in the resource library are associated with particular keywords or anchor terms that may be used to identify appropriate templates for different project or task categories or types. Accordingly, based on the one or more parameters corresponding to the issue that is to be addressed, the task creation sub-system may query the resource library to identify and obtain any templates that correspond to these one or more parameters.

At step 806, the task creation sub-system may present the available templates to the representative via the representative console. For instance, as illustrated in FIGS. 3A and 4, the task creation sub-system may update a template selection window of the representative console to provide iconic representations of the identified templates that may be used to create a new project or task. In some instances, the task creation sub-system may also provide the representative, via the representative console, with an option to utilize a default template to create a new project or task. The default template may be modified by the representative using the representative console to define a new template for a particular project/task or type of project/task, as described above.

At step 808, the task creation sub-system may detect selection of a particular template from the representative console. For instance, the task creation sub-system may monitor, in real-time, representative interaction with the representative console to detect any interaction with an iconic representation of a particular template or with an option (e.g., button or other graphical user interface (GUI) element of the representative console) to utilize a default template to define a new project or task and to create a new custom template that may be used for similar projects/tasks or project/task types.

In response to representative selection of a particular template or of a default template for the creation of a new project or task, the task creation sub-system, at step 810, may update the representative console to present the selected template. For example, as illustrated in FIG. 5, the task creation sub-system may update the representative console to present a task creation window 130, through which the task creation sub-system may present different data fields for defining the project or task, whereby the different project or task fields may correspond to the project/task type or category for the project or task being defined. The representative may provide information related to the issue that is to be addressed via these different data fields to define the project or task that may be submitted to the task creation sub-system for processing.

At step 812, the task creation sub-system may determine whether definition of a new project or task using the selected template has been completed. For instance, the task creation sub-system may monitor, in real-time, representative interaction with the various data fields of the selected template, as well as with a button or other GUI element (e.g., add task button 520, as illustrated in FIG. 5), to determine whether the representative has submitted a request to enter the new project or task using the parameters defined via the myriad fields presented within the selected template. If the task creation sub-system determines that the representative has not completed definition of the new project or task, the task creation sub-system may continue to monitor, in real-time, the representative's interaction with the various data fields of the selected template and with a button or other GUI element corresponding to submission of the new project or task.

If the task creation sub-system determines that the representative has completed defining a new project or task that may be performed for the benefit of the member, the task creation sub-system may, at step 814, present the new project or task via the representative console. For instance, as noted above, the task creation sub-system may add the new project or task to the listing of tasks or projects that are to be performed for the benefit of the member. Further, the newly created task or project may be ranked according to a likelihood of the member selecting the task or project for delegation to the representative for performance and coordination with third-party services. Alternatively, the new task or project may be ranked based on the level of urgency for completion of each project or task. The level of urgency may be determined based on member characteristics from the user datastore (e.g., data corresponding to a member's own prioritization of certain tasks or categories of tasks) and/or potential risks to the member if the task or project is not performed.

In an embodiment, once the representative has completed defining a new project or task that may be performed for the benefit of the member, the task creation sub-system can update the interface generated for the corresponding project or task to include the information defined by the representative and/or by the task creation sub-system for the project or task. As noted above, if the task creation sub-system identifies a project or task that may be performed in order to address an issue expressed by the member over the original communications session facilitated between the member and the representative, the task creation sub-system may automatically generate a new interface for the newly identified project or task. Through this new interface, the task creation sub-system may facilitate a communications session that is specific to the identified project or task. Further, in response to the representative having completed defining a new project or task, the task creation sub-system may automatically update this interface to provide any updated information related to the identified project or task and provided by the representative or otherwise identified by the task creation sub-system.

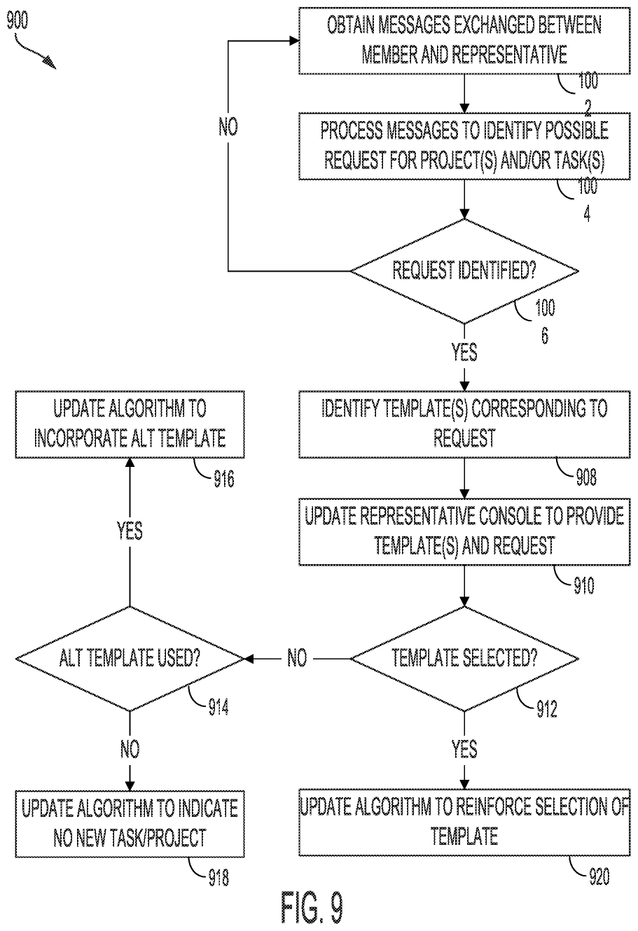

FIG. 9 shows an illustrative example of a process 900 for automatically identifying templates usable to generate a new project or task based on messages exchanged between a member and an assigned representative in accordance with at least one embodiment. The process 900 may be performed by a task creation sub-system of the task recommendation system. As noted above, the task creation sub-system may automatically, and in real-time, process messages exchanged over the communications session between a representative and a member as these messages are exchanged to identify an issue expressed by the member. Based on this identified issue, the task creation sub-system may identify one or more applicable templates that may be used to define a new project or task for addressing the issue, as described herein.

At step 902, the task creation sub-system may automatically, and in real-time, obtain messages between a representative and a member over a communications session established by the task facilitation service as these messages are being exchanged. For instance, the task creation sub-system may maintain a data stream or feed through which messages exchanged between the member and the representative are transmitted to the task creation sub-system automatically and in real-time as these messages are being exchanged between the member and the representative. Alternatively, the task creation sub-system may actively monitor the communications session between the member and the representative to obtain any newly exchanged messages in real-time.

At step 904, the task creation sub-system may process these messages to identify any possible request for creation of a new project and/or task that may be performed to address an issue specified by the member. These messages may be processed in real-time and as the messages are exchanged to identify an issue expressed by the member. For instance, the task creation sub-system may utilize a machine learning algorithm, such as an NLP algorithm, or other artificial intelligence to process these messages exchanged between the member and the representative over the communications session to identify an issue expressed by the member, for which a new project and/or task may be generated to address the issue. In some instances, the task creation sub-system may identify one or more keywords or anchor terms that may correspond to particular issues. For instance, as noted above, the task creation sub-system may implement one or more classical algorithms or processes that may be used to automatically identify one or more templates that may be provided to the representative for defining a new project or task. These one or more classical algorithms or processes may automatically, and in real-time, process communications between the member and the representative through the communications session as these communications are exchanged and automatically determine whether these communications include one or more anchor terms or phrases corresponding to an issue that the member would like resolved.

At step 906, the task creation sub-system may determine whether a request to address a particular issue (e.g., create a new project or task) has been identified. As noted above, the task creation sub-system may use a machine learning algorithm or artificial intelligence to process, in real-time, messages exchanged between a member and a representative as these messages are being exchanged to identify any issues that the member would like to have addressed. Alternatively, the task creation sub-system may use one or more classical algorithms or processes to automatically detect any keywords or anchor terms/phrases that may correspond to an issue that the member would like resolved. The identification of particular keywords or anchor terms may allow the task creation sub-system to any issues expressed by the member for which one or more projects and/or tasks may be generated. Using the illustrative example provided above in connection with FIG. 1, if the member transmits the message “I need help planning a move to Bayamon next month,” the task creation sub-system may automatically identify the keywords “help” and “move,” which may be indicative of a request for help and for creation of a new project or task related to moving, respectively. If the task creation sub-system does not identify a request for assistance with a particular issue and to generate a new project or task to address the issue, the task creation sub-system may continue to obtain and process, automatically and in real-time, messages between the member and the representative as these messages are exchanged over the communications session.

If the task creation sub-system determines that a request to address a particular issue has been identified, the task creation sub-system, at step 908, may identify one or more templates that may correspond to the request. For instance, as noted above, the templates maintained by the task facilitation service for defining new projects and tasks are associated with particular keywords or anchor terms that may be used to identify appropriate templates for different project or task categories or types. For example, a template corresponding to vehicle maintenance projects and tasks may be associated with the keywords “vehicle,” “automobile,” “car,” “van,” “engine,” and the like. Accordingly, if the member indicates, via a message to the representative over the communications session, that the member would like assistance with replacing the engine on the member's car, the task creation sub-system may use the keywords “engine” and “car” to identify any templates corresponding to vehicle maintenance projects and tasks from the resource library.

At step 910, the task creation sub-system may update the representative console provided by the task facilitation service to the representative to provide the identified templates and the request from the member to address the particular issue. As noted above, the task creation sub-system may update a template selection window of the representative console to provide iconic representations of the identified templates that may be used to create a new project or task. In some instances, the task creation sub-system may also provide the representative, via the representative console, with an option to utilize a default template to create a new project or task. The default template may be modified by the representative using the representative console to define a new template for a particular project/task or type of project/task, as described above.

At step 912, the task creation sub-system may determine whether the representative has selected a template identified by the task creation sub-system as corresponding to the issue specified by the member. For instance, the task creation sub-system may monitor, in real-time, representative interaction with the representative console to detect any interaction with an iconic representation of a particular template or with an option (e.g., button or other GUI element of the representative console) to utilize a default template to define a new project or task and to create a new custom template that may be used for similar projects/tasks or project/task types.

If the task creation sub-system determines that the representative has selected a template recommended by the task creation sub-system to define a new project or task for addressing the issue expressed by the member, the task creation sub-system, at step 920, may update the machine learning algorithm or artificial intelligence used to identify the one or more templates corresponding to the issue to further reinforce the machine learning algorithm or artificial intelligence. This reinforcement may increase the likelihood of the machine learning algorithm of artificial intelligence recommending the selected template for similar issues and for similarly-situated members of the task facilitation service.

If the task creation sub-system determines that none of the recommended templates have been selected for creation of a new project or task based on the identified issue, the task creation sub-system, at step 914, may determine whether an alternative template has been used. For instance, as noted above, the task creation sub-system may present, via the representative console, a task/project creation button, through which the representative may request a default template that may be used to define a new project or task to address the issue expressed by the member. If the representative selects this task/project creation button, the task creation sub-system may determine that the representative has opted to create a new project or task using the default template instead of any of the recommended templates. As another example, via the representative console, if the representative does not want to use any of the recommended templates, the representative may query the resource library to identify a particular template that may be more relevant to the identified issue for creation of a new project or task. In some instances, the representative may determine, based on their knowledge of the member and a review of the messages corresponding to the identified issue, that no new projects or tasks are required.

If the representative has selected an alternative template (e.g., defined a new template from a default template, selected a different template from the resource library, etc.) for creation of a project or task for addressing the identified issue, the task creation sub-system, at step 916, may update the machine learning algorithm or artificial intelligence used to recommend templates based on identified issues to incorporate this alternative template. For instance, the task creation sub-system may use this as feedback that may be used to update the dataset used to initially train the machine learning algorithm or artificial intelligence. Using this updated dataset, the task creation sub-system may retrain the machine learning algorithm or artificial intelligence utilized to recommend templates that may be used to define new projects and tasks for a particular issue. The task creation sub-system may use the new custom template generated by the representative or the alternative template selected from the task datastore, the messages exchanged over the communications session indicative of the issue for which the new project or task was generated, and the templates rejected by the representative as a new datapoint for the dataset used to train the machine learning algorithm or artificial intelligence. This updated dataset may be used as input to the machine learning algorithm or artificial intelligence for retraining of the machine learning algorithm or artificial intelligence. This process may increase the likelihood of the machine learning algorithm or artificial intelligence selecting the new custom template generated by the representative or the alternative template selected from the task datastore for similar issues and for similarly-situated members of the task facilitation service.

If the representative has not selected an alternative template and has instead indicated that no new project or task is to be generated for the identified issue, the task creation sub-system, at step 918, may update the machine learning algorithm or artificial intelligence to increase the likelihood of the machine learning algorithm or artificial intelligence foregoing selection of a template for similar issues and for similarly-situated members. The task creation sub-system may use the representative's rejection of the recommended templates, the representative's indication that no new project or task is to be created for the identified issue, and the messages exchanged over the communications session indicative of the issue the create a new datapoint that may be added to the dataset used to train the machine learning algorithm or artificial intelligence. This updated dataset may be used as input to the machine learning algorithm or artificial intelligence to retrain the machine learning algorithm or artificial intelligence. This may increase the likelihood of the machine learning algorithm or artificial intelligence foregoing recommendation of a template for similar issues and for similarly situated members.

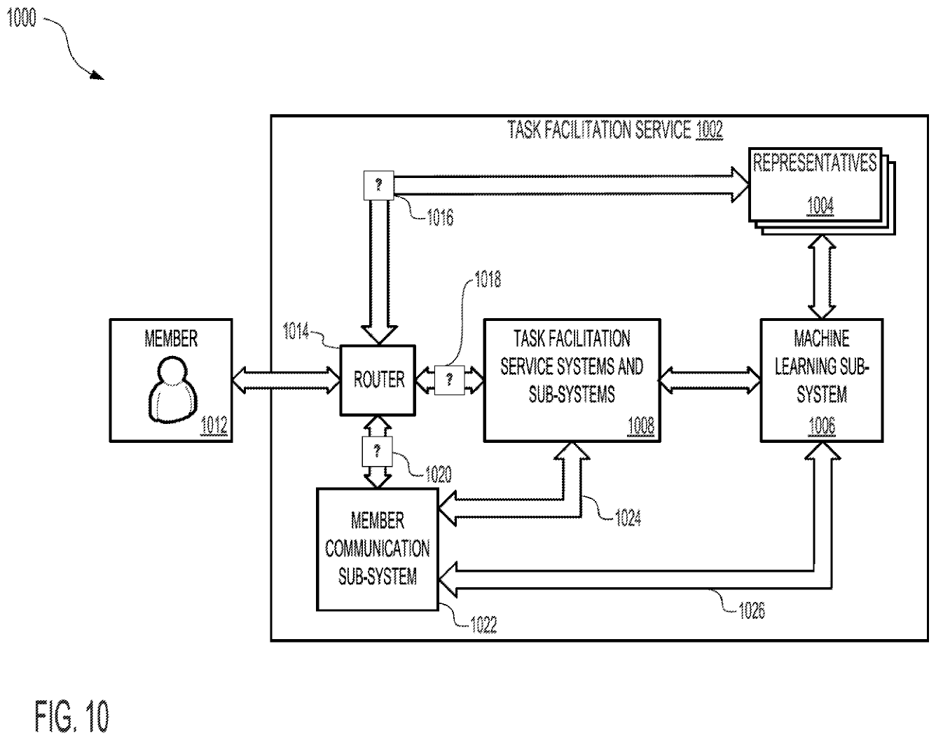

FIG. 10 shows an illustrative example of an environment 1000 in which communications with members are processed in accordance with at least one embodiment. In an embodiment, operations performed by representatives 1004 are partially and/or fully performed using one or more machine learning algorithms, artificial intelligence systems and/or computational models. For example, as the representatives 1004 perform or otherwise coordinate performance of tasks on behalf of a member 1012, the task facilitation service 1002 may update a profile of the member 1012 and/or a computational model of the profile of the member 1012.

In an embodiment, as the representatives 1004 perform or otherwise coordinate performance of tasks on behalf of a member 1012, the task facilitation service 1002 updates a profile of the member 1012 and/or a computational model of the profile of the member 1012 continuously. For example, as a member 1012 communicates with a system of the task facilitation service 1002, the task facilitation service 1002 may update the profile of the member 1012 and/or a computational model of the profile of the member 1012 continuously during the course of the interaction.

In an embodiment, as the representatives 1004 perform or otherwise coordinate performance of tasks on behalf of a member 1012, the task facilitation service 1002 updates a profile of the member 1012 and/or a computational model of the profile of the member 1012 dynamically. For example, as a task is performed on behalf of a member 1012, a vendor performing the task may provide regular updates to the task facilitation service 1002 and the task facilitation service 1002 may update the profile of the member 1012 and/or a computational model of the profile of the member 1012 dynamically at each update from the vendor.

In an embodiment, as the representatives 1004 perform or otherwise coordinate performance of tasks on behalf of a member 1012, the task facilitation service 1002 updates a profile of the member 1012 and/or a computational model of the profile of the member 1012 automatically. For example, when a proposal is generated for the member, the task facilitation service 1002 may update the profile of the member 1012 and/or a computational model of the profile of the member 1012 automatically as part of the proposal generation process.

In an embodiment, as the representatives 1004 perform or otherwise coordinate performance of tasks on behalf of a member 1012, the task facilitation service 1002 updates a profile of the member 1012 and/or a computational model of the profile of the member 1012 in real-time. For example, when a member 1012 accepts a proposal, the task facilitation service 1002 may update the profile of the member 1012 and/or a computational model of the profile of the member 1012 at the time that the proposal acceptance is provided, rather than delaying the update.

In an embodiment, the task facilitation service 1002 updates a profile of the member 1012 and/or a computational model of the profile of the member 1012 using a machine learning sub-system 1006 of the task facilitation service 1002. In an embodiment, a machine learning sub-system 1006 is a component of the task facilitation service 1002 that is configured to implement machine learning algorithms, artificial intelligence systems, and/or computation models. In an example, a machine learning sub-system 1006 may use various algorithms to train a machine learning model using sample and/or live data. Additionally, a machine learning sub-system 1006 may update the machine learning model as new data is received. In another example, the machine learning sub-system 1006 may train and/or update various artificial intelligence systems or generate, train and/or update various computational models. For example, a computational model of the profile of the member 1012 may be generated, trained and/or updated by the machine learning sub-system 1006 as new information is received about the member 1012.

In an embodiment, after the profile of the member 1012 and/or a computational model of the profile of the member 1012 has been updated over a period of time (e.g., six months, a year, etc.) and/or over a set of tasks (e.g., twenty tasks, thirty tasks, etc.), systems of the task facilitation service 1002 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 1002 (e.g., a task recommendation system) can automatically communicate with the member 1012 to obtain any additional information needed and can also generate proposals that may be presented to the member 1012 for performance of these tasks.

In the example illustrated in FIG. 10, communications between the member 1012 and the task facilitation service 1002 may be routed to one or more entities within the task facilitation service 1002. The example illustrated in FIG. 10 shows a communication router 1014 (referred to in the illustration as a “router”) however, as may be contemplated and as illustrated in FIG. 10, the router 1014 is an abstract representation of one or more techniques for routing communications between entities. Accordingly, communications from the member 1012 to the task facilitation service 1002 may be routed to one or more entities of the task facilitation service and communications from the one or more entities of the task facilitation service 1002 may be routed back to the member 1012.

In the example illustrated in FIG. 10, the representatives 1004 can monitor communications between task facilitation service systems and/or sub-systems 1008 and the member 1012 to ensure that the interaction maintains a positive polarity as described herein because the communications can be routed 1016 to the representatives 1004 and also routed 1018 to task facilitation service systems and/or sub-systems 1008. For example, if a member 1012 is interacting with the task recommendation system, the representatives 1004 can determine whether the member 1012 is satisfied with the interaction. If the representatives 1004 determine that the conversation has a negative polarity (e.g., that the member 1012 is not satisfied with the interaction), the representatives 1004 may intervene to improve the interaction.

Similarly, other interactions between task facilitation service systems and/or sub-systems 1008 and the member 1012 may be routed 1020 to a member communication sub-system 1022 which may be configured to monitor the interactions between task facilitation service systems and/or sub-systems 1008 and the member 1012. In an embodiment, the member communication sub-system 1022 can be configured to intercept the interactions between task facilitation service systems and/or sub-systems 1008 and the member 1012 (using, for example, the router 1014). In such an embodiment, all such interactions can be routed 1020 between the member 1012 and the member communication sub-system 1022 and can be routed 1024 between the member communication sub-system 1022 and the task facilitation service systems and/or sub-systems 1008. In such an embodiment, interactions between the task facilitation service systems and/or sub-systems 1008 and the member 1012 may not be routed 1018 directly. In such an embodiment, the representatives 1004 may still monitor interactions between task facilitation service systems and/or sub-systems 1008 and the member 1012 to ensure that the interaction maintains a positive polarity as described above (e.g., by routing 1016 the interactions to the representatives 1004).

In an embodiment, the representatives 1004 can interact with the machine learning sub-system 1006 to update the profile of the member indicating changing member preferences based on an interaction between the representatives 1004 the member 1012. In an embodiment, the task facilitation service systems and/or sub-systems 1008 can interact with the machine learning sub-system 1006 to update the profile of the member when, for example, a proposal is accepted or rejected. Additionally, as illustrated in FIG. 10, the interactions between the task facilitation service 1002 and the member 1012 can be additionally routed 1026 between the member communication sub-system 1022 and the machine learning sub-system 1006. Accordingly, interactions between the member 1012 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 1008 can update the profile of the member 1012 and/or a computational model of the profile of the member 1012 continuously, dynamically, automatically, and/or in real-time. For example, task facilitation service systems and/or sub-systems 1008 can update the profile of the member 1012 and/or a computational model of the profile of the member 1012 using the machine learning sub-system 1006 as described herein. Accordingly, task facilitation service systems and/or sub-systems 1008 can update the profile of the member 1012 and/or a computational model of the profile of the member 1012 to provide up-to-date information about the member based on the member's automatic interaction with the task facilitation service 1002, based on the member's interaction with the representative 1004, and/or based on tasks performed on behalf of the member 1012 over time. This information may also be updated continuously, automatically, dynamically, and/or in real-time as tasks and/or proposals are created, proposed, and performed for the member 1012. This information may also be used by the task facilitation service 1002 to anticipate, identify, and present appropriate or intelligent interactions with the member 1012 (e.g., in response to member 1012 queries, needs, and/or goals).

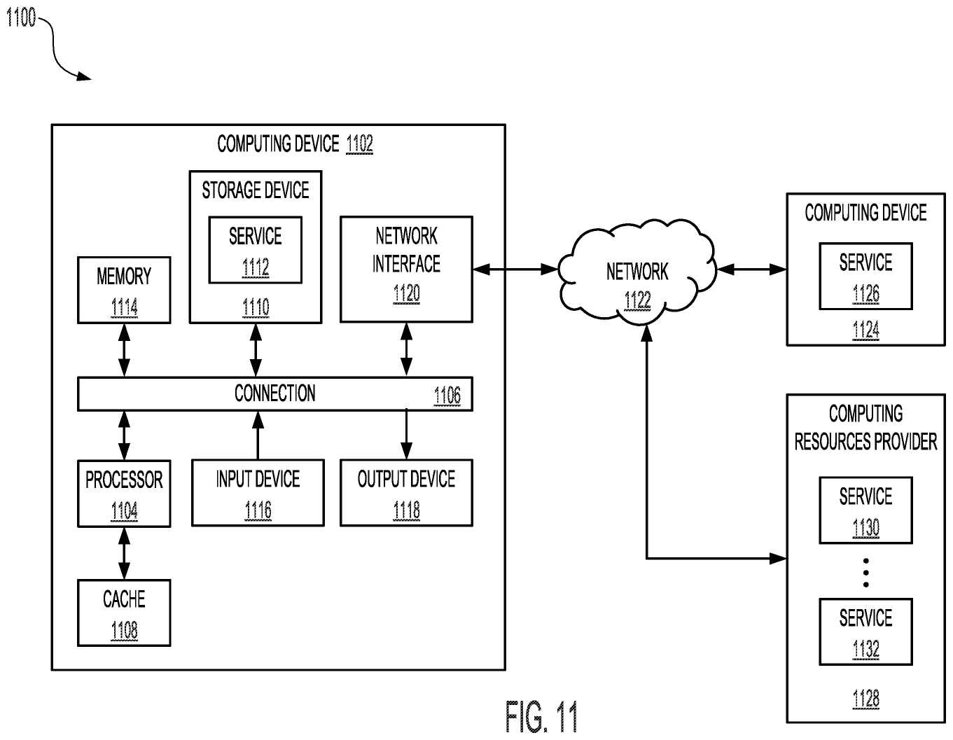

FIG. 11 illustrates a computing system architecture 1100, including various components in electrical communication with each other, in accordance with some embodiments. The example computing system architecture 1100 illustrated in FIG. 11 includes a computing device 1102, which has various components in electrical communication with each other using a connection 1106, such as a bus, in accordance with some implementations. The example computing system architecture 1100 includes a processing unit 1104 that is in electrical communication with various system components, using the connection 1106, and including the system memory 1114. In some embodiments, the system memory 1114 includes read-only memory (ROM), random-access memory (RAM), and other such memory technologies including, but not limited to, those described herein. In some embodiments, the example computing system architecture 1100 includes a cache 1108 of high-speed memory connected directly with, in close proximity to, or integrated as part of the processor 1104. The system architecture 1100 can copy data from the memory 1114 and/or the storage device 1110 to the cache 1108 for quick access by the processor 1104. In this way, the cache 1108 can provide a performance boost that decreases or eliminates processor delays in the processor 1104 due to waiting for data. Using modules, methods and services such as those described herein, the processor 1104 can be configured to perform various actions. In some embodiments, the cache 1108 may include multiple types of cache including, for example, level one (L1) and level two (L2) cache. The memory 1114 may be referred to herein as system memory or computer system memory. The memory 1114 may include, at various times, elements of an operating system, one or more applications, data associated with the operating system or the one or more applications, or other such data associated with the computing device 1102.

Other system memory 1114 can be available for use as well. The memory 1114 can include multiple different types of memory with different performance characteristics. The processor 1104 can include any general purpose processor and one or more hardware or software services, such as service 1112 stored in storage device 1110, configured to control the processor 1104 as well as a special-purpose processor where software instructions are incorporated into the actual processor design. The processor 1104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1104 can be a microprocessor, a microcontroller, a digital signal processor (“DSP”), or a combination of these and/or other types of processors. In some embodiments, the processor 1104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1100, an input device 1116 can represent any number of input mechanisms, such as a microphone for speech, a touch-sensitive screen for gesture or graphical input, keyboard, mouse, motion input, pen, and other such input devices. An output device 1118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1100. In some embodiments, the input device 1116 and/or the output device 1118 can be coupled to the computing device 1102 using a remote connection device such as, for example, a communication interface such as the network interface 1120 described herein. In such embodiments, the communication interface can govern and manage the input and output received from the attached input device 1116 and/or output device 1118. As may be contemplated, there is no restriction on operating on any particular hardware arrangement and accordingly the basic features here may easily be substituted for other hardware, software, or firmware arrangements as they are developed.

In some embodiments, the storage device 1110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1110 can include hardware and/or software services such as service 1112 that can control or configure the processor 1104 to perform one or more functions including, but not limited to, the methods, processes, functions, systems, and services described herein in various embodiments. In some embodiments, the hardware or software services can be implemented as modules. As illustrated in example computing system architecture 1100, the storage device 1110 can be connected to other parts of the computing device 1102 using the system connection 1106. In an embodiment, a hardware service or hardware module such as service 1112, that performs a function can include a software component stored in a non-transitory computer-readable medium that, in connection with the necessary hardware components, such as the processor 1104, connection 1106, cache 1108, storage device 1110, memory 1114, input device 1116, output device 1118, and so forth, can carry out the functions such as those described herein.

The disclosed processed for generating and executing experience recommendations can be performed using a computing system such as the example computing system illustrated in FIG. 11, using one or more components of the example computing system architecture 1100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 1104 wherein the code is stored in memory such as memory 1114 as described herein. One or more of a user device, a provider server or system, a database system, or other such devices, services, or systems may include some or all of the components of the computing system such as the example computing system illustrated in FIG. 11, using one or more components of the example computing system architecture 1100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1104 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1114 can be coupled to the processor 1104 by, for example, a connector such as connector 1106, or a bus. As used herein, a connector or bus such as connector 1106 is a communications system that transfers data between components within the computing device 1102 and may, in some embodiments, be used to transfer data between computing devices. The connector 1106 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 1114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1114 can also include magnetic or optical data storage media including read-only (e.g., CD ROM and DVD ROM) or otherwise (e.g., CD or DVD). The memory can be local, remote, or distributed.

As described above, the connector 1106 (or bus) can also couple the processor 1104 to the storage device 1110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1106 can also couple the processor 1104 to a network interface device such as the network interface 1120. The interface can include one or more of a modem or other such network interfaces including, but not limited to those described herein. It will be appreciated that the network interface 1120 may be considered to be part of the computing device 1102 or may be separate from the computing device 1102. The network interface 1120 can include one or more of an analog modem, Integrated Services Digital Network (ISDN) modem, cable modem, token ring interface, satellite transmission interface, or other interfaces for coupling a computer system to other computer systems. In some embodiments, the network interface 1120 can include one or more input and/or output (I/O) devices. The I/O devices can include, by way of example but not limitation, input devices such as input device 1116 and/or output devices such as output device 1118. For example, the network interface 1120 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and decendents, Xenix™ SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1102 can be connected to one or more additional computing devices such as computing device 1124 via a network 1122 using a connection such as the network interface 1120. In such embodiments, the computing device 1124 may execute one or more services 1126 to perform one or more functions under the control of, or on behalf of, programs and/or services operating on computing device 1102. In some embodiments, a computing device such as computing device 1124 may include one or more of the types of components as described in connection with computing device 1102 including, but not limited to, a processor such as processor 1104, a connection such as connection 1106, a cache such as cache 1108, a storage device such as storage device 1110, memory such as memory 1114, an input device such as input device 1116, and an output device such as output device 1118. In such embodiments, the computing device 1124 can carry out the functions such as those described herein in connection with computing device 1102. In some embodiments, the computing device 1102 can be connected to a plurality of computing devices such as computing device 1124, each of which may also be connected to a plurality of computing devices such as computing device 1124. Such an embodiment may be referred to herein as a distributed computing environment.

The network 1122 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1122 can be wired connections, wireless connections, or combinations thereof. Communications via the network 1122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1122, within the computing device 1102, within the computing device 1124, or within the computing resources provider 1128 can include information, which also may be referred to herein as content. The information may include text, graphics, audio, video, haptics, and/or any other information that can be provided to a user of the computing device such as the computing device 1102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1102 and presented to a user of the computing device 1102 using forms that are perceptible via sight, sound, smell, taste, touch, or other such mechanisms. In some embodiments, communications over the network 1122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1102 and/or the computing device 1124 can be connected to a computing resources provider 1128 via the network 1122 using a network interface such as those described herein (e.g. network interface 1120). In such embodiments, one or more systems (e.g., service 1130 and service 1132) hosted within the computing resources provider 1128 (also referred to herein as within “a computing resources provider environment”) may execute one or more services to perform one or more functions under the control of, or on behalf of, programs and/or services operating on computing device 1102 and/or computing device 1124. Systems such as service 1130 and service 1132 may include one or more computing devices such as those described herein to execute computer code to perform the one or more functions under the control of, or on behalf of, programs and/or services operating on computing device 1102 and/or computing device 1124.

For example, the computing resources provider 1128 may provide a service, operating on service 1130 to store data for the computing device 1102 when, for example, the amount of data that the computing device 1102 exceeds the capacity of storage device 1110. In another example, the computing resources provider 1128 may provide a service to first instantiate a virtual machine (VM) on service 1132, use that VM to access the data stored on service 1132, perform one or more operations on that data, and provide a result of those one or more operations to the computing device 1102. Such operations (e.g., data storage and VM instantiation) may be referred to herein as operating “in the cloud,” “within a cloud computing environment,” or “within a hosted virtual machine environment,” and the computing resources provider 1128 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1128 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1130 and service 1132 may implement versions of various services (e.g., the service 1112 or the service 1126) on behalf of, or under the control of, computing device 1102 and/or computing device 1124. Such implemented versions of various services may involve one or more virtualization techniques so that, for example, it may appear to a user of computing device 1102 that the service 1112 is executing on the computing device 1102 when the service is executing on, for example, service 1130. As may also be contemplated, the various services operating within the computing resources provider 1128 environment may be distributed among various systems within the environment as well as partially distributed onto computing device 1124 and/or computing device 1102.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1102) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 6-8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1102.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving a set of messages in real-time, wherein the set of messages is between a member and a representative, and wherein the set of messages is received as the set of messages is being exchanged;
automatically identifying an issue, wherein the issue is identified based on the set of messages;
identifying one or more templates for defining a task, wherein the task is performable to address the issue, wherein the one or more templates are identified using a trained machine learning algorithm, and wherein the trained machine learning algorithm uses the set of messages and a set of available templates as input to identify the one or more templates;
presenting the one or more templates, wherein when a template from the one or more templates is selected to define the task, the task is generated;
performing the task, wherein the task is performed according to one or more parameters associated with the task, and wherein the one or more parameters are defined using the template; and
updating the trained machine learning algorithm, wherein the trained machine learning algorithm is updated using the task, the template, and the set of messages.

2. The computer-implemented method of claim 1, further comprising:
processing the set of messages using a Natural Language Processing (NLP) algorithm to identify one or more anchor terms, wherein the one or more anchor terms correspond to the issue.

3. The computer-implemented method of claim 1, further comprising:
generating one or more proposal options for completion of the task, wherein the one or more proposal options are generated based on the task, and wherein when a proposal option is selected, the task is performed according to the selected proposal option.

4. The computer-implemented method of claim 1, further comprising:
updating a console to present data fields for defining the one or more parameters associated with the task, wherein the console is updated when the template is selected to define the task, and wherein the data fields correspond to a task type associated with the task.

5. The computer-implemented method of claim 1, further comprising:
dynamically generating one or more prompts for additional information, wherein when the one or more prompts are generated, the one or more prompts are provided to obtain the additional information; and
updating the template based on the additional information.

6. The computer-implemented method of claim 1, further comprising:
facilitating a communications session corresponding to the task, wherein the communications session is facilitated between the member and the representative; and
automatically presenting information corresponding to the task through the communications session.

7. The computer-implemented method of claim 1, further comprising:
transmitting a notification in response to identifying the issue, wherein when the notification is received by the representative, the issue and the one or more templates are dynamically presented to the representative.

8. A system, comprising:
one or more processors; and
memory storing thereon instructions that, as a result of being executed by the one or more processors, cause the system to:
receive in real-time a set of messages between a member and a representative as the set of messages are being exchanged;
automatically identify an issue, wherein the issue is identified based on the set of messages;
identify one or more templates for defining a task, wherein the task is performable to address the issue, wherein the one or more templates are identified using a trained machine learning algorithm, and wherein the trained machine learning algorithm uses the set of messages and a set of available templates as input to identify the one or more templates;
present the one or more templates, wherein when a template from the one or more templates is selected to define the task, the task is generated;
perform the task, wherein the task is performed according to one or more parameters associated with the task, and wherein the one or more parameters are defined using the template; and
update the trained machine learning algorithm, wherein the trained machine learning algorithm is updated using the task, the template, and the set of messages.

9. The system of claim 8, wherein the instructions that cause the system to automatically identify the issue further cause the system to:
process the set of messages using a Natural Language Processing (NLP) algorithm to identify one or more anchor terms, wherein the one or more anchor terms correspond to the issue.

10. The system of claim 8, wherein the instructions further cause the system to:
generate one or more proposal options for completion of the task, wherein the one or more proposal options are generated based on the task, and wherein when a proposal option is selected, the task is performed according to the selected proposal option.

11. The system of claim 8, wherein the instructions further cause the system to:
update a console to present data fields for defining the one or more parameters associated with the task, wherein the console is updated when the template is selected to define the task, and wherein the data fields correspond to a task type associated with the task.

12. The system of claim 8, wherein the instructions further cause the system to:
dynamically generate one or more prompts for additional information, wherein when the one or more prompts are generated, the one or more prompts are provided to obtain the additional information; and
update the template based on the additional information.

13. The system of claim 8, wherein the instructions further cause the system to:
facilitate a communications session corresponding to the task, wherein the communications session is facilitated between the member and the representative; and
automatically present information corresponding to the task through the communications session.

14. The system of claim 8, wherein the instructions further cause the system to:
transmit a notification in response to identifying the issue, wherein when the notification is received by the representative, the issue and the one or more templates are dynamically presented to the representative.

15. A non-transitory, computer-readable storage medium storing thereon executable instructions that, as a result of being executed by a computer system, cause the computer system to:
receive in real-time a set of messages between a member and a representative as the set of messages are being exchanged;
automatically identify an issue, wherein the issue is identified based on the set of messages;
identify one or more templates for defining a task, wherein the task is performable to address the issue, wherein the one or more templates are identified using a trained machine learning algorithm, and wherein the trained machine learning algorithm uses the set of messages and a set of available templates as input to identify the one or more templates;
present the one or more templates, wherein when a template from the one or more templates is selected to define the task, the task is generated;
perform the task, wherein the task is performed according to one or more parameters associated with the task, and wherein the one or more parameters are defined using the template; and
update the trained machine learning algorithm, wherein the trained machine learning algorithm is updated using the task, the template, and the set of messages.

16. The non-transitory, computer-readable storage medium of claim 15, wherein the executable instructions that cause the computer system to:
automatically identify the issue further cause the computer system to process the set of messages using a Natural Language Processing (NLP) algorithm to identify one or more anchor terms, wherein the one or more anchor terms correspond to the issue.

17. The non-transitory, computer-readable storage medium of claim 15, wherein the executable instructions further cause the computer system to:
generate one or more proposal options for completion of the task, wherein the one or more proposal options are generated based on the task, and wherein when a proposal option is selected, the task is performed according to the selected proposal option.

18. The non-transitory, computer-readable storage medium of claim 15, wherein the executable instructions further cause the computer system to:
update a console to present data fields for defining the one or more parameters associated with the task, wherein the console is updated when the template is selected to define the task, and wherein the data fields correspond to a task type associated with the task.

19. The non-transitory, computer-readable storage medium of claim 15, wherein the executable instructions further cause the computer system to:
dynamically generate one or more prompts for additional information, wherein when the one or more prompts are generated, the one or more prompts are provided to obtain the additional information; and
update the template based on the additional information

20. The non-transitory, computer-readable storage medium of claim 15, wherein the executable instructions further cause the computer system to:
facilitate a communications session corresponding to the task, wherein the communications session is facilitated between the member and the representative; and
automatically present information corresponding to the task through the communications session.

21. The non-transitory, computer-readable storage medium of claim 15, wherein the executable instructions further cause the computer system to:
transmit a notification in response to identifying the issue, wherein when the notification is received by the representative, the issue and the one or more templates are dynamically presented to the representative.
